(19) United States
(12) Patent Application Publication
(10) Pub. No.: US 2026/0062591 A1
(43) Pub. Date: Mar. 5, 2026

(54) BONDING OF LIQUID-METAL ELASTOMER COMPOSITES TO SUBSTRATES

(71) Applicant: VIRGINIA TECH INTELLECTUAL PROPERTIES, INC., Blacksburg, VA (US)

(72) Inventors: Michael D. BARTLETT, Blacksburg, VA (US); Dohgyu HWANG, Blacksburg, VA (US); Edward J. BARRON, III, Blacksburg, VA (US); Tyler A. POZARYCKI, Blacksburg, VA (US)

(21) Appl. No.: 19/106,118

(22) PCT Filed: Jun. 23, 2023
(86) PCT No.: PCT/US2023/026139

§ 371 Date: Feb. 24, 2025

Related U.S. Application Data
(60) Provisional application No. 63/400,371, filed on Aug. 23, 2022.

(51) Int. Cl. C09J 5/02

(52) U.S. Cl. CPC C09J 5/02; C09J 2203/326; C09J 2400/166; C09J 2400/228; C09J 2483/00

(57) ABSTRACT

In various aspects, the disclosure relates to methods of adhering a liquid metal composite to a substrate. The method can include applying a pretreatment to a surface of the substrate to form an activated surface. In some aspects, the pretreatment is an oxygen plasma treatment. The methods can then include contacting a silane with the activated surface to form a functionalized surface. A variety of suitable silanes may be used, but in some instances the silane is aminopropyltriethoxysilane (APTES). The method then includes contacting the functionalized surface with a liquid metal composite precursor and curing the liquid metal composite precursor while in contact with the functionalized surface to form the liquid metal composite adhered to the substrate. Articles made by the methods are also provided, including articles such as electronics having the liquid metal composite adhered to a substrate using the methods described herein.

### CROSS-REFERENCE TO RELATED APPLICATIONS

This application claims the benefit of U.S. Provisional Application No. 63/400,371, filed on Aug. 23, 2022 and entitled “TOUGH BONDING OF LIQUID-METAL ELASTOMER COMPOSITES FOR MULTIFUNCTIONAL ADHESIVES,” which is incorporated herein by reference in its entirety.

### STATEMENT REGARDING FEDERALLY SPONSORED RESEARCH

This disclosure was made with government support under Agreement No. N00014112699, awarded by the Office of Naval Research, and Agreement No. D18AP00041, awarded by the Defense Advanced Research Projects Agency (DARPA). The government has certain rights in the invention.

### BACKGROUND

Soft materials with high stretchability, conformability, and thermal and electrical conductivity are critical for emerging applications in soft robotics and electronics systems.¹⁻⁸ Recently, soft composites consisting of liquid metal (LM) droplets dispersed in highly deformable elastomers have gained particular interest, as these materials are soft and stretchable yet display exceptional mechanical, thermal, and electrical properties.⁹⁻¹⁹ For example, LM composites can act as soft wiring for wearable devices, yet be flexible enough to seamlessly interface with the contours of human tissue.²⁰⁻²⁴ Liquid metal and LM composites are also useful as thermal interface materials (TIMs) for electronic components to improve heat dissipation.^{14, 25-28} To fully utilize LM composites for applications in soft robotics, wearable computing, and reconfigurable systems, they must be integrated with and attached to different components and interfaces. However, current integration strategies rely primarily on physical attachment, clamping, and encapsulation,^{9, 15, 29, 30} and strategies to strongly bond LM composites to diverse materials are lacking.

Thus, there is a continuing need for improved methods of integrating and interfacing LM composites to a variety of substrates.

### SUMMARY

In various aspects, the disclosure provides methods of adhering a liquid metal composite to a substrate, articles prepared by the methods, and various devices utilizing the articles. Not wishing to be bound by any particular theory, it is believed that use of a silane, for example, an amino alkyl silane can assist in forming a very tough bond between the substrate and the liquid metal composite to the extent that the liquid metal composite itself fractured as opposed to experiencing surface debonding when exposed to a separating force.

In some aspects, the disclosure includes a method of adhering a liquid metal composite to a substrate, the method comprising applying a pretreatment to a surface of the substrate to form an activated surface; contacting a silane with the activated surface to form a functionalized surface; contacting the functionalized surface with a liquid metal composite precursor and curing the liquid metal composite precursor while in contact with the functionalized surface to form the liquid metal composite adhered to the substrate.

In some aspects, the disclosure includes an article prepared according to the above methods. The articles can include or be incorporated in a variety of devices. In particular aspects, the articles include electronics or electronic components such as heat sinks, computer processors, and the like. In some aspects, the electronics are flexible electronics.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic representation of a liquid metal composite adhesion to a substrate without chemical anchoring.

FIG. 2 is a schematic representation of a liquid metal composite adhesion to a substrate with chemical anchoring, according to the present disclosure.

FIG. 3 is a graph of fracture energy (G_{c}) in J m⁻² versus displacement for a representative LM composite undergoing peeling. The representative LM composite has a volume fraction (φ) of 20% and a liquid metal droplet diameter (d) of 2 μm.

FIG. 4 is a bar graph of fracture energies (G_{c}) in J m⁻² of untreated and chemically anchored representative LM composites. The representative LM composited have a volume fraction (φ) of 20% and a liquid metal droplet diameter (d) of 2 μm. Error bars represent the standard deviation for n=3.

FIG. 5 is an image demonstrating the difference between adhesive (left side) and cohesive (right side) failures of a representative LM composite sample in T-peel without (left side) and with (right side) APTES surface treatment. The representative LM composite has a volume fraction (φ) of 20% and a liquid metal droplet diameter (d) of 2 μm.

FIGS. 6A-6B are images of the crack front of a representative LM composite adhesive undergoing cohesive fracture. The representative LM composite has a volume fraction (φ) of 20% and a liquid metal droplet diameter (d) of 2 μm. The scale in FIG. 6A is 5 mm. FIG. 6B is a close-up image of the region depicted by dashed lines in FIG. 6A and with a scale of 500 μm.

FIG. 7A-7B depict the crack front of a representative LM composite adhesive undergoing cohesive fracture. The representative LM composite has a volume fraction (φ) of 20% and a liquid metal droplet diameter (d) of 2 μm. FIG. 7A is an image of the crack front with a scale of 200 μm. FIG. 7B is a schematic illustration of liquid metal droplet elongation at the crack front.

FIG. 8 is a bar graph of the fracture energies (G_{c}) in J m⁻² of representative LM composites in T-peel as a function of the volume fraction (%) of liquid metals. Error bars represent the standard deviation for n=3. The representative liquid metal composites have a liquid metal droplet diameter (d) of 2 μm, 15 μm, and 60 μm.

FIG. 9 is a graph of the fracture energies (G_{c}) in J m⁻² of representative LM composites as a function of the elastic modulus in kPa. The representative liquid metal composites have a liquid metal droplet diameter (d) of 2 μm, 15 μm, and 60 μm.

FIG. 10 is a graph of the fracture energies (G_{c}) in J m⁻² of representative LM composites as a function of the thermal conductivity in units of W m⁻¹ K⁻¹. The representative liquid metal composites have a liquid metal droplet diameter (d) of 2 μm, 15 μm, and 60 μm.

FIG. 11 is a bar graph of the fracture energy (G_{c}) in J m⁻² of a representative LM composite on varied substrate surfaces using a 90° peel. The representative LM composite has a volume fraction (φ) of 40% and a liquid metal droplet diameter (d) of 15 μm. The substrates include acrylic, aluminum, copper, and glass. Error bars represent the standard deviation for n=3.

FIG. 12 is an image of the cohesive failure of a 90° peel sample of the representative LM composite from FIG. 11 on copper.

FIG. 13 is a graph of the measured GPU temperature (° C.) for a Visiontek Radeon 5450 graphics card as a function of time(s) measured by the GPU thermocouple during idle and benchmark tests with either (i) a stock card using the as-received thermal compound between the GPU and the heatsink, (ii) using an Ecoflex resin between the GPU and the heatsink, or (iii) using a representative LM composite between the GPU and the heatsink. The representative LM composite has a volume fraction (φ) of 60% and a liquid metal droplet diameter (d) of 60 μm.

FIG. 14 is a bar graph of the refresh rate (Hz) of the graphics card with the stock configuration and with LM composite and a siloxane elastomer (Ecoflex) as replacements for the thermal interface material.

FIG. 15 is an image of the suspension of both the heatsink (66 grams) and an additional 50 grams from a chemically anchored LM composite.

FIG. 16 is a schematic representation of a representative integrated LM composite device.

FIG. 17. is a set of thermal profiles of a siloxane elastomer (Ecoflex) (top images) and representative LM composite samples (bottom images) after 80 s.

FIG. 18 is a set of timelapse images of a siloxane elastomer (Ecoflex) sample showing thermal failure of the LED (ii) and adhesive failure at the bottom copper contact (iii).

FIG. 19 is a set of timelapse images of a LM composite showing high stretchability and heat dissipation and eventual fracture through the bottom neck (v-vi) at ˜310% global applied strain.

FIG. 20 is a set of images of LM composite thin film (from left to right) chemically anchored to an LED and supporting acrylic substrate, hand-stretching, hand torsion, and stress applied directly to the LED while pulling with tweezers.

FIG. 21 is a set of micrographs of liquid metal droplets in LM composites. Columns show different LM volume loadings (φ) of =20%, 40%, and 60% respectively. Rows show different LM droplet sizes (d) of 2 μm, 15 μm, and 60 μm respectively. All micrographs use a scale bar of 50 μm.

FIGS. 22A-22B show the results from a micrograph analysis of a representative LM composite with small droplets. The representative LM composite has a volume fraction (φ) of 20%. FIG. 22A is a micrograph image of the representative LM composite. FIG. 22B is a particle distribution histogram of the particle distribution from the micrograph in FIG. 22A.

FIGS. 23A-23B show the results from a micrograph analysis of a representative LM composite with medium-sized droplets. The representative LM composite has a volume fraction (φ) of 60%. FIG. 23A is a micrograph image of the representative LM composite. FIG. 23B is a particle distribution histogram of the droplet distribution from the micrograph in FIG. 23A.

FIGS. 24A-24B show the results from a micrograph analysis of a representative LM composite with large-sized droplets. The representative LM composite has a volume fraction (φ) of 60%. FIG. 24A is a micrograph image of the representative LM composite. FIG. 24B is a particle distribution histogram of the droplet distribution from the micrograph in FIG. 24A.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Bonding LM composites to substrates, particularly polymers, is challenging due to their low surface energy and lack of functional groups.³¹⁻³⁴ One method is to utilize substrates with fibrous or porous structures to allow for mechanical interlocking between the elastomer and substrate.^{35, 36} However, in many cases, bonding to smooth substrates is desired. Another approach is to perform plasma treatment on the materials for surface cleaning and activation. Plasma bonding is a common technique for adhering silicone elastomers such as PDMS to various surfaces,^{37, 38} yet there are limitations to the effectiveness of the technique when used with silicones of high plasticizer content. For example, commercial silicones such as Ecoflex are widely used for LM composites and other applications in soft electronics and soft robotics, but their high content of silicone oils leads to challenges with plasma bonding.³¹ Silicone surfaces treated with oxygen plasma experience hydrophobic recovery over time due to surface fouling with contaminants and diffusion of unreacted oligomer to the surface, both of which decrease bonding capabilities shortly after treatment. One way to overcome limited work time is to incorporate chemical treatment across interfaces. For example, substrates can be coated with chemical primers such as cyanoacrylates to allow for strong bonding with other materials.³⁹⁻⁴¹ However, hardened cyanoacrylates can generate a mechanical compliance mismatch with deformable materials, resulting in significant stress concentrations and interfacial failures.

One promising approach to solve this problem is to treat desired surfaces with functional silanes before bonding.⁴² Silane treatment of a material alters its surface chemistry, thus avoiding compliance mismatches generated by the addition of adhesive materials at interfaces. The organosilane (3-aminopropyl)triethoxysilane (APTES) has demonstrated the ability to create stable siloxane bonds between silicones and hydroxylated substrates.⁴³⁻⁴⁵ However, there is limited work on bonding LM composites through surface treatments and to silane-functionalized surfaces surface, both of which decrease bonding capabilities shortly after treatment.³²

The present disclosure provides a solution to integrating or interfacing a liquid metal composite with a substrate surface. Adhering the liquid metal composite to the substrate can be accomplished by applying a pretreatment to a surface of the substrate to form an activated surface; contacting a silane with the activated surface to form a functionalized surface; contacting the functionalized surface with a liquid metal composite precursor; and curing the liquid metal composite precursor while in contact with the functionalized surface to form the liquid metal composite adhered to the substrate.

For example, in some instances described herein, it has been demonstrated that by contacting a substrate surface with the silane aminopropyltriethoxysilane (APTES) following oxygen plasma treatment of the surface can create a functionalized surface suitable for strongly adhering the liquid metal composite. When the liquid metal composite is cured onto such a surface, strong adhesion occurs such that the interfacial adhesion exceeds the fracture strength of the composite material. This is true for a variety of substrates from metal, to glass, and to polymer substrates.

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which can be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications, patents, and patent applications mentioned or cited herein are incorporated herein by reference to disclose and describe the methods and/or materials in connection with which the publications, patents, or patent applications are cited. All such publications, patents, and patent applications are herein incorporated by references as if each individual publication, patent, or patent application were specifically and individually indicated to be incorporated by reference. Such incorporation by reference is expressly limited to the methods and/or materials described in the cited publications, patents, and patent applications and does not extend to any lexicographical definitions from the cited publications, patents, and patent applications. Any lexicographical definition in the publications, patents, and patent applications cited, including any lexicographical definition in any patent or patent application in the priority claim, that is not also expressly repeated in the instant specification should not be treated as such and should not be read as defining any terms appearing in the accompanying claims. The publications, patents, and patent applications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

Reference to “a/an” chemical compound, protein, and antibody each refers to one or more molecules of the chemical compound, protein, and antibody rather than being limited to a single molecule of the chemical compound, protein, and antibody. Furthermore, the one or more molecules may or may not be identical, so long as they fall under the category of the chemical compound, protein, and antibody. Thus, for example, “an” antibody is interpreted to include one or more antibody molecules of the antibody, where the antibody molecules may or may not be identical (e.g., different isotypes and/or different antigen binding sites as may be found in a polyclonal antibody).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “contacting” as used herein refers to bringing a disclosed analyte, compound, chemical, or material in proximity to another disclosed analyte, compound, chemical, or material as indicated by the context. For example, an analyte contacting an antibody refers to the analyte being in proximity to the antibody by the analyte interacting and binding to the antibody via ionic, dipolar and/or van der Waals interactions. In some instances, contacting can comprise both physical and chemical interactions between the indicated components. It is to be understood that chemical interactions can comprise a combination of covalent and non-covalent interactions, including one or more of ionic, dipolar, van der Waals interactions, and the like. For example, one layer contacting a substrate layer is understood to mean that the one layer is in physical and chemical contact with the substrate layer that can comprise covalent, ionic, and non-covalent interactions.

As used herein, the terms “optional” or “optionally” means that the subsequently described event or circumstance can or cannot occur, and that the description includes instances where said event or circumstance occurs and instances where it does not.

As used herein, the term “liquid metal” means substances or compounds that refer to gallium, alloyed gallium, e.g., alloyed with another element such as indium, tin and/or zinc.

### Methods of Making a Liquid Metal Composite Adhered to a Substrate

In various aspects, methods of adhering a liquid metal composite to a substrate are provided herein. It has been found that, through a judicious selection of silanes, surface preparation of a substrate, and liquid metal composites, that an article can be produced with a strong adhesion between the composite and the substrate when the liquid metal composite is cured while in contact with the substrate.

In some aspects, a method is provided for adhering a liquid-metal polysiloxane composite to a substrate, e.g., a rigid substrate. In some aspects, the substrate will have undergone a surface preparation treatment before contact with the liquid metal polysiloxane composite. In some aspects, the surface preparation treatment can form an activated surface on the substrate.

In some aspects, the surface, e.g., the activated surface, can be contacted with a silane. In some aspects, the surface, e.g., the activated surface, can be contacted by a solution including a silane and an acceptable solvent.

In some aspects, the silane-treated surface can be contacted with a composition containing a liquid metal composite precursor. In this or other aspects, the composite precursor can be a flowable liquid, a flowable solid, a gel, and combinations thereof.

In some aspects, the silane-treated surface, while in contact with the liquid metal composite precursor can be cured.

### Substrates

Various substrates are described herein that can be activated and contacted with the siloxane and/or silane as described herein and demonstrated in the examples.

In some instances, the substrate is a metal. For example, the metal can be a metal selected from the group consisting of titanium, copper, aluminum, iron, nickel, zinc, and chromium, and alloys comprising any one or more of the foregoing metals. In some instances, the alloy can include 2, 3, 4, 5, 6 or 7 of these metals, all combinations of which are to be considered separate aspects. In some instances, the alloy can be considered a stainless steel, as understood by person of ordinary skill in the art.

In some instances, the substrate is electrically conductive. Electrically conductive means that the resistivity of the substrate is from about 1×10⁻⁶ Ω-m to about 10×10⁻⁶ Ω-m.

In some instances, the substrate is a non-metal. In some instances, the substrate is a plastic. In some instances, the selected from the group consisting of an acrylate a methacrylate, a siloxane, a polysiloxane, a polyethylene, a polypropylene, a polybutylene, a polycarbonate, a polyvinyl chloride, a polyester, a copolyester, a polycarbonate, an acrylonitrile butadiene styrene (ABS), and blends and composites thereof.

In some instances, the substrate is electrically non-conductive. Electrically non-conductive means that the resistivity of the substrate is from about 10⁵ Ω-m to about 10¹⁰ Ω-m. In some instances, the substrate is an insulator.

In some instances, the substrate is a rigid substrate, or a rigid sheet. The term rigid in some instances can mean that the substrate has a Young's modulus as measured according to ASTM E111 protocol of from 50 GPa to 200 GPa (gigapascals). The ASTM E111 protocol is known to a person of ordinary skill in the art, and in particular, the ASTM E111-17 protocol, issued Sep. 8, 2017, “Standard Test Method for Young's Modulus, Tangent Modulus, and Chord Modulus”, available from ASTM, at ASTM Headquarters, 100 Barr Harbor Drive, West Conshohoken, Pennsylvania, 19428-2959, USA.

In some instances, the Young's Modulus of the substrate can be from 50 GPa to 180 GPa, or from about 50 GPa to 160 about GPa, or from 50 GPa to 140 GPa, or from 50 GPa to 120 GPa, or from 50 GPa to 100 GPa, or from 50 GPa to 80 GPa, or from 70 GPa to 90 GPa, or from 90 GPa to 110 GPa, or from 110 GPa to about 130 GPa, or from about 130 GPa to about 150 GPa, or from 150 GPa to about 170 GPa, or from about 170 GPa to about 200 GPa.

In some instances, the substrate has a Young's modulus as measured according to ASTM E111 protocol of from 0.001 GPa to 10 GPa (gigapascals). In such instances, the substrate can be a non-metal, e.g., a plastic, e.g., a substrate selected from the group consisting of an acrylate a methacrylate, a siloxane, a polysiloxane, a polyethylene, a polypropylene, a polybutylene, a polycarbonate, a polyvinyl chloride, a polyester, a copolyester, a polycarbonate, an acrylonitrile butadiene styrene (ABS), and blends and composites thereof.

In some instances, the substrate, e.g., the non-metal substrate, has a Young's modulus from about 0.0001 GPa to about 0.001 GPa, or from about 0.001 GPa to about 0.01 GPa, or from about 0.01 GPa to 0.1 GPa, or from about 0.1 to about 1 GPa, or from about 1 GPa to about 2 GPa, or from about 2 GPa to about 3 GPa, or from about 3 GPa to about 4 GPa, or from about 4 GPa to about 5 GPa, or from about 5 GPa to about 6 GPa, or from about 6 GPa to about 7 GPa, or from about 7 GPa to about 8 GPa, or from about 8 GPa to about 9 GPa, or from 9 GPa to about 10 GPa.

### Activated Surface of a Substrate

In some instances, a surface of a substrate can be activated by techniques known the person of ordinary skill in the art. Such an activation can be referred to herein as a substrate pretreatment. Such pretreatment can include an ozone treatment, oxygen plasma treatment, wet oxidation treatment, electrochemical oxidation, and a combination thereof. In other instances, an argon plasma can be used as a pretreatment. Such pretreatment is as described herein and demonstrated in the examples.

### Silane

In some instances, the silane is an alkyl silane. For example, the compound R—Si(OEt)₃, wherein R is alkyl, can be referred to as an alkyl silane. In some instances, the silicon atom on the silane, e.g, the alkyl silane, has one alkoxy group, two alkoxy groups, or two or more alkoxy groups, or three alkoxy group. The term “alkoxy” can mean lower alkoxy, for example, methoxy, ethoxy, n-propoxy, isopropoxy, n-butoxy, isobutoxy, sec-butoxy, and tert-butoxy. Each alkoxy group is independently chosen from another.

In some instances, the silane comprises an amino or an amino alkyl group. In some instances, the term alkyl means lower alkyl, for example, methyl, ethyl, n-propyl, n-butyl, isobutyl, sec-butyl, and tert-butyl. Generally, the silane comprises one or two amino alkyl groups.

In some instances, the silane comprises from 1 to 4 vinyl groups, in particular, 1, 2, or 3 vinyl groups. In such an instance, the silane can comprise 1, 2, or 3 alkyl groups and/or alkoxy groups, wherein alkyl means lower alkyl, as defined supra. In some instances, the silane is selected from the group consisting of trimethoxysilane (TMS), triethoxysilane (TES), aminopropyltriethoxysilane (APTES), vinyltrimethoxysilane (VTMS), and a combination thereof.

In some instances, the (aminoalkyl)trialkoxysilane is a compound of formula (I):

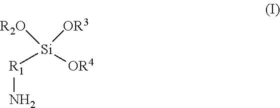

wherein R₁ is a C₂ to C₆ divalent linear alkylene radical optionally substituted by one or more halogen; and

R₂, R₃, and R₄ are independently selected from methyl, ethyl, propyl, isopropyl, n-butyl, isobutyl, sec-butyl, and tert-butyl.

In some instances, R₁ is CH₂CH₂—, CH₂CH₂CH₂—, —CH₂CH₂CH₂CH₂—, —CH₂CH₂CH₂CH₂CH₂—, or —CH₂CH₂CH₂CH₂CH₂CH₂—; or R₁ is CH₂CH₂—, CH₂CH₂CH₂—, —CH₂CH₂CH₂CH₂— or CH₂CH₂CH₂CH₂CH₂; or R₁ is CH₂CH₂—, CH₂CH₂CH₂—, or —CH₂CH₂CH₂CH₂—; or R₁ is CH₂CH₂— or CH₂CH₂CH₂—; or R₁ is CH₂CH₂— or CH₂CH₂CH₂—.

### Solvent

In some instances, the silane is contacted with the activated surface in a solution comprising the silane and a solvent. The solvent can be any that is acceptable to provide an even, non-precipitating coating of the silane on the activated surface. For example, a normal alcohol can be utilized as the solvent. In some instances, the solvent is selected from the group consisting of methanol, ethanol, n-propanol, combinations thereof, and mixtures thereof comprising one or more additional solvents. In some instances, the solvent comprises ethanol. In some instances, the solvent consists essentially of ethanol. In some instances, the solvent consists of ethanol.

In some instances, the solvent can be substantially anhydrous or anhydrous.

Substantially anhydrous can mean that the solvent comprises less than about 1% water, or less than about 0.9% water, or less than about 0.8% water, or less than about 0.7% water, or less than about 0.6% water or less than about 0.5% water, or less than about 0.4% water, or less than about 0.3% water, or less than about 0.2% water, or less than about 0.1% water, or less than about 0.05% water, or less than about 0.01% water. All percentages are by weight (w/w).

In some instances, the silane can be dissolved in the solvent at concentration of from about 0.05 vol % to about 2 vol %. In some instances, the silane can be dissolved in the solvent at a concentration of about 0.05 vol %, about 0.1 vol %, about 0.15 vol %, about 0.20 vol %, about 0.25 vol %, about 0.30 vol %, about 0.35 vol %, about 0.40 vol %, about 0.45 vol %, about 0.50 vol %, about 0.55 vol %, about 0.60 vol %, about 0.65 vol %, about 0.70 vol %, about 0.75 vol %, about 0.80 vol %, about 0.85 vol %, about 0.90 vol %, about 0.95 vol %, about 1.00 vol %, about 1.05 vol %, about 1.10 vol %, about 1.15 vol %, about 1.20 vol %, about 1.25 vol %, about 1.30 vol %, about 1.35 vol %, about 1.40 vol %, about 1.45 vol %, about 1.50 vol %, about 1.55 vol %, about 1.60 vol %, about 1.65 vol %, about 1.70 vol %, about 1.75 vol %, about 1.80 vol %, about 1.85 vol %, about 1.90 vol %, about 1.95 vol %, or about 2.00 vol %; or the concentration can be within a range from one number to another in the preceding array of vol % s.

In some instances, the silane can be dried on the substrate by evaporation of the solvent. In this instance, drying is performed for a first period of time from about 0.5 hours to 24 hours, or from about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, or about 24 hours; or the drying time can be within a range from one number to another in the preceding array of drying times. In some instances, during the drying step the substrate can be heated to from 30° C. to about 50° C., e.g., a temperature that will allow the solvent to evaporate within the first time period.

In some instances, the curing the liquid metal composite precursor comprises one or more processes. The processes can include of heating the liquid metal composite precursor, exposing the liquid metal composite precursor to UV radiation, and/or contacting the liquid metal composite precursor with a chemical crosslinking agent. When the curing process comprises heating, the curing comprises heating the liquid metal composite precursor to an elevated temperature for a second period of time.

In this sense, the curing time can be from about 1, about 2, about 3, about 4, about 5, about 6, about 7, about 8, about 9, about 10, about 11, about 12, about 15, about 18, about 21, about 24, about 30, about 36, about 42, or about 48 hours; or the concentration can be within a range from one number to another in the preceding array of hours.

In some instances, the liquid metal composite precursor includes an uncured elastomeric polymer having droplets of liquid metal dispersed therein. In other instances, the elastomeric polymer is partially cured having droplets of liquid metal dispersed therein.

In some instances, the elastomeric polymer is selected from the group consisting of a polysilane, a polyurethane, a polyacrylate, a natural rubber, copolymers thereof, and blends thereof. In some instances, the elastomeric polymer comprises a polysiloxane elastomer. As known to the person of ordinary skill in the art, the polysiloxane elastomer can be platinum-curable, tin-curable, and/or heat curable. Such polysiloxane elastomers are commercially available as uncured liquids.

In certain instances, the metal within the liquid metal composite can selected from the group consisting of gallium, eutectic gallium indium, gallium alloys, gallium-indium-tin, mercury, and combinations thereof. In certain instances, the liquid metal is selected from the group consisting of gallium GaIn_{24.5}, (eutectic gallium indium or EgaIn), Ga₆₇In_{20.5}Sn_{12.5} (Galinstan), and Ga₆₁In₂₅Sn₁₃Zn₁.

In certain instances, the metal is dispersed in the liquid metal composite in a volume fraction of liquid metal in the composite of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%; or at a volume fraction from one number to another number in the preceding array of percentages.

In some aspects, the diameter of the liquid metal drop or droplet is from about 1 μm to about 100 μm, or 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, or about 100 μm; or the diameter of the liquid metal drop or droplet is from one number to another number in the preceding array of numbers.

In another aspect of the disclosure, the method comprises 3D printing of the liquid metal composite precursor onto the functionalized surface and curing the 3D printed liquid metal composite precursor contemporaneous with or immediately after the 3D printing step. Such 3D printing techniques are known to the person of ordinary skill in the art of 3D printing

In another aspect, the disclosure includes an article prepared by the method of the disclosure, wherein the article includes the substrate and the liquid metal composite adhered to the substrate. In some instances, the article can include an electronic component adhered to the liquid metal composite. For example, a heat sink, a printed circuit board, and/or other electronic components can be adhered to the liquid metal composite.

### REFERENCES

References may be cited herein using the format of reference number(s) enclosed by parentheses corresponding to one or more of the following numbered references. References may also be cited herein using a superscript format. For example, citation of references numbers 1 and 2 immediately herein below could be indicated in the disclosure as (Refs. 1 and 2) or as the superscript “1-2.”
[1] D.-H. Kim, N. Lu, R. Ma, Y.-S. Kim, R.-H. Kim, S. Wang, J. Wu, S. M. Won, H. Tao, A. Islam, et al., “Epidermal electronics,” Science, vol. 333, no. 6044, pp. 838-843, 2011.
[2] R. F. Shepherd, F. Ilievski, W. Choi, S. A. Morin, A. A. Stokes, A. D. Mazzeo, X. Chen, M. Wang, and G. M. Whitesides, “Multigait soft robot,” Proceedings of the national academy of sciences, vol. 108, no. 51, pp. 20400-20403, 2011.
[3] A. Tonazzini, S. Mintchev, B. Schubert, B. Mazzolai, J. Shintake, and D. Floreano, “Variable stiffness fiber with self-healing capability,” Advanced Materials, vol. 28, no. 46, pp. 10142-10148, 2016.
[4] D. Hwang, E. J. Barron III, A. T. Haque, and M. D. Bartlett, “Shape morphing mechanical metamaterials through reversible plasticity,” Science Robotics, vol. 7, no. 63, p. eabg2171, 2022.
[5] D. Rus and M. T. Tolley, “Design, fabrication and control of soft robots,” Nature, vol. 521, no. 7553, pp. 467-475, 2015.
[6] E. J. Barron III, R. S. Peterson, N. Lazarus, and M. D. Bartlett, “Mechanically cloaked multiphase magnetic elastomer soft composites for wearable wireless power transfer,” ACS Applied Materials & Interfaces, vol. 12, no. 45, pp. 50909-50917, 2020.
[7] J. Kang, J. B.-H. Tok, and Z. Bao, “Self-healing soft electronics,” Nature Electronics, vol. 2, no. 4, pp. 144-150, 2019.
[8] Z. J. Farrell, C. J. Thrasher, A. E. Flynn, and C. E. Tabor, “Silanized liquid-metal nanoparticles for responsive electronics,” ACS Applied Nano Materials, vol. 3, no. 7, pp. 6297-6303, 2020.
[9] M. D. Bartlett, N. Kazem, M. J. Powell-Palm, X. Huang, W. Sun, J. A. Malen, and C. Majidi, “High thermal conductivity in soft elastomers with elongated liquid metal inclusions,” Proceedings of the National Academy of Sciences, vol. 114, no. 9, pp. 2143-2148, 2017.
[10] G. G. Guymon and M. H. Malakooti, “Multifunctional liquid metal polymer composites,” Journal of Polymer Science, vol. 60, no. 8, pp. 1300-1327, 2022.
[11] C. Majidi, K. Alizadeh, Y. Ohm, A. Silva, and M. Tavakoli, “Liquid metal polymer composites: from printed stretchable circuits to soft actuators,” Flexible and Printed Electronics, vol. 7, no. 1, p. 013002, 2022.
[12] M. D. Dickey, “Stretchable and soft electronics using liquid metals,” Advanced Materials, vol. 29, no. 27, p. 1606425, 2017.
[13] Chen, H.-Z. Wang, R.-Q. Zhao, W. Rao, and J. Liu, “Liquid metal composites,” Matter, vol. 2, no. 6, pp. 1446-1480, 2020.
[14] A. T. Haque, R. Tutika, R. L. Byrum, and M. D. Bartlett, “Programmable liquid metal microstructures for multifunctional soft thermal composites,” Advanced Functional Materials, vol. 30, no. 25, p. 2000832, 2020.
[15] E. J. Markvicka, M. D. Bartlett, X. Huang, and C. Majidi, “An autonomously electrically self-healing liquid metal-elastomer composite for robust soft-matter robotics and electronics,” Nature materials, vol. 17, no. 7, pp. 618-624, 2018.
[16] R. Tutika, A. Haque, and M. D. Bartlett, “Self-healing liquid metal composite for reconfigurable and recyclable soft electronics,” Communications Materials, vol. 2, no. 1, pp. 1-8, 2021.
[17] L. Mou, J. Qi, L. Tang, R. Dong, Y. Xia, Y. Gao, and X. Jiang, “Highly stretchable and biocompatible liquid metal-elastomer conductors for self-healing electronics,” Small, vol. 16, no. 51, p. 2005336, 2020.
[18] S. G. Wallace, N. P. Bradshaw, N. X. Williams, J. H. Qian, K. W. Putz, C. E. Tabor, and M. C. Hersam, “Combustion-assisted photonic sintering of printed liquid metal nanoparticle films,” Advanced Materials Technologies, p. 2101178, 2021.
[19] N. Pekas, Q. Zhang, and D. Juncker, “Electrostatic actuator with liquid metal-elastomer compliant electrodes used for on-chip microvalving,” Journal of Micromechanics and Microengineering, vol. 22, no. 9, p. 097001, 2012.
[20] P. A. Lopes, D. F. Fernandes, A. F. Silva, D. G. Marques, A. T. de Almeida, C. Majidi, and M. Tavakoli, “Bi-phasic ag-in-ga-embedded elastomer inks for digitally printed, ultra-stretchable, multi-layer electronics,” ACS Applied Materials & Interfaces, vol. 13, no. 12, pp. 14552-14561, 2021.
[21] A. Hajalilou, A. F. Silva, P. A. Lopes, E. Parvini, C. Majidi, and M. Tavakoli, “Biphasic liquid metal composites for sinter-free printed stretchable electronics,” Advanced Materials Interfaces, vol. 9, no. 5, p. 2101913, 2022.
[22] Y. Lin, C. Cooper, M. Wang, J. J. Adams, J. Genzer, and M. D. Dickey, “Handwritten, soft circuit boards and antennas using liquid metal nanoparticles,” Small, vol. 11, no. 48, pp. 6397-6403, 2015.
[23] A. Fassler and C. Majidi, “Liquid-phase metal inclusions for a conductive polymer composite,” Advanced Materials, vol. 27, no. 11, pp. 1928-1932, 2015.
[24] S. Liu, S. Y. Kim, K. E. Henry, D. S. Shah, and R. Kramer-Bottiglio, “Printed and laser-activated liquid metal-elastomer conductors enabled by ethanol/pdms/liquid metal double emulsions,” ACS Applied Materials & Interfaces, vol. 13, no. 24, pp. 28729-28736, 2021.
[25] W. Kong, Z. Wang, M. Wang, K. C. Manning, A. Uppal, M. D. Green, R. Y. Wang, and K. Rykaczewski, “Oxide-mediated formation of chemically stable tungsten-liquid metal mixtures for enhanced thermal interfaces,” Advanced Materials, vol. 31, no. 44, p. 1904309, 2019.
[26] E. J. Krings, H. Zhang, S. Sarin, J. E. Shield, S. Ryu, and E. J. Markvicka, “Lightweight, thermally conductive liquid metal elastomer composite with independently controllable thermal conductivity and density,” Small, p. 2104762, 2021.
[27] X. Wang, C. Lu, and W. Rao, “Liquid metal-based thermal interface materials with a high thermal conductivity for electronic cooling and bioheat-transfer applications,” Applied Thermal Engineering, vol. 192, p. 116937, 2021.
[28] H. Wang, W. Xing, S. Chen, C. Song, M. D. Dickey, and T. Deng, “Liquid metal composites with enhanced thermal conductivity and stability using molecular thermal linker,” Advanced Materials, vol. 33, no. 43, p. 2103104, 2021.
[29] C. Pan, D. Liu, M. J. Ford, and C. Majidi, “Ultrastretchable, wearable triboelectric nanogenerator based on sedimented liquid metal elastomer composite,” Advanced Materials Technologies, vol. 5, no. 11, p. 2000754, 2020.
[30] P. Wu, J. Fu, Y. Xu, and Y. He, “Liquid metal microgels for three-dimensional printing of smart electronic clothes,” ACS Applied Materials & Interfaces, vol. 14, no. 11, pp. 13458-13467, 2022.
[31] S. Park, K. Mondal, R. M. Treadway III, V. Kumar, S. Ma, J. D. Holbery, and M. D. Dickey, “Silicones for stretchable and durable soft devices: beyond sylgard-184,” ACS applied materials & interfaces, vol. 10, no. 13, pp. 11261-11268, 2018.
[32] J. Roth, V. Albrecht, M. Nitschke, C. Bellmann, F. Simon, S. Zschoche, S. Michel, C. Luhmann, K. Grundke, and B. Voit, “Surface functionalization of silicone rubber for permanent adhesion improvement,” Langmuir, vol. 24, no. 21, pp. 12603-12611, 2008.
[33] D. Brewis and D. Briggs, “Adhesion to polyethylene and polypropylene,” Polymer, vol. 22, no. 1, pp. 7-16, 1981.
[34] D. Zhang, Q. Sun, and L. C. Wadsworth, “Mechanism of corona treatment on polyolefin films,” Polymer Engineering & Science, vol. 38, no. 6, pp. 965-970, 1998.
[35] A. M. Hubbard, W. Cui, Y. Huang, R. Takahashi, M. D. Dickey, J. Genzer, D. R. King, and J. P. Gong, “Hydrogel/elastomer laminates bonded via fabric interphases for stimuli-responsive actuators,” Matter, vol. 1, no. 3, pp. 674-689, 2019.
[36] L. Rossing, R. B. Scharff, B. Chömpff, C. C. Wang, and E. L. Doubrovski, “Bonding between silicones and thermoplastics using 3d printed mechanical interlocking,” Materials & Design, vol. 186, p. 108254, 2020.
[37] L. Xiong, P. Chen, and Q. Zhou, “Adhesion promotion between pdms and glass by oxygen plasma pre-treatment,” Journal of Adhesion Science and Technology, vol. 28, no. 11, pp. 1046-1054, 2014.
[38] S. Bhattacharya, A. Datta, J. M. Berg, and S. Gangopadhyay, “Studies on surface wettability of poly (dimethyl) siloxane (pdms) and glass under oxygen-plasma treatment and correlation with bond strength,” Journal of microelectromechanical systems, vol. 14, no. 3, pp. 590-597, 2005.
[39] L. A. Bloomfield, “Primer system for bonding conventional adhesives and coatings to silicone rubber,” International Journal of Adhesion and Adhesives, vol. 68, pp. 239-247, 2016.
[40] J. Yang and A. Garton, “Primers for adhesive bonding to polyolefins,” Journal of applied polymer science, vol. 48, no. 2, pp. 359-370, 1993.
[41] T. Yin, G. Zhang, S. Qu, and Z. Suo, “Peel of elastomers of various thicknesses and widths,” Extreme Mechanics Letters, vol. 46, p. 101325, 2021.
[42] J. W. Krumpfer and T. J. McCarthy, “Rediscovering silicones: “unreactive” silicones react with inorganic surfaces,” Langmuir, vol. 27, no. 18, pp. 11514-11519, 2011.
[43] H. Yuk, T. Zhang, G. A. Parada, X. Liu, and X. Zhao, “Skin-inspired hydrogel-elastomer hybrids with robust interfaces and functional microstructures,” Nature communications, vol. 7, no. 1, pp. 1-11, 2016.
[44] J. M. Taylor, K. Perez-Toralla, R. Aispuro, and S. A. Morin, “Covalent bonding of thermoplastics to rubbers for printable, reel-to-reel processing in soft robotics and microfluidics,” Advanced Materials, vol. 30, no. 7, p. 1705333, 2018.
[45] T. An, S. Gong, Y. Ling, D. Dong, Y. Zhao, and W. Cheng, “Dynamically functioning and highly stretchable epidermal supercapacitor based on vertically aligned gold nanowire skins,” EcoMat, vol. 2, no. 2, p. e12022, 2020.
[46] T. Shen, Y. Liu, Y. Zhu, D.-Q. Yang, and E. Sacher, “Improved adhesion of ag nps to the polyethylene terephthalate surface via atmospheric plasma treatment and surface functionalization,” Applied Surface Science, vol. 411, pp. 411-418, 2017.
[47] A. Y. Fadeev and T. J. McCarthy, “Surface modification of poly (ethylene terephthalate) to prepare surfaces with silica-like reactivity,” Langmuir, vol. 14, no. 19, pp. 5586-5593, 1998.
[48] E. P. Plueddemann, Silane Coupling Agents. Springer US, 1982.
[49] A. Gent and R. Tobias, “Effect of interfacial bonding on the strength of adhesion of elastomers. iii. interlinking by molecular entanglements,” Journal of Polymer Science: Polymer Physics Edition, vol. 22, no. 8, pp. 1483-1490, 1984.
[50] J. Gohl, T. Thiele-Sardina, M. Rencheck, K. Erk, and C. Davis, “A modular peel fixture for tape peel tests on immovable substrates,” Experimental Mechanics, vol. 61, no. 7, pp. 1209-1213, 2021.
[51] N. Kazem, M. D. Bartlett, and C. Majidi, “Extreme toughening of soft materials with liquid metal,” Advanced Materials, vol. 30, no. 22, p. 1706594, 2018.
[52] S. Lee and M. Pharr, “Sideways and stable crack propagation in a silicone elastomer,” Proceedings of the National Academy of Sciences, vol. 116, no. 19, pp. 9251-9256, 2019.
[53] B. Chen and D. A. Dillard, “The effect of the t-stress on crack path selection in adhesively bonded joints,” International journal of adhesion and adhesives, vol. 21, no. 5, pp. 357-368, 2001.
[54] C. Chiew and M. H. Malakooti, “A double inclusion model for liquid metal polymer composites,” Composites Science and Technology, vol. 208, p. 108752, 2021.
[55] R. W. Style, R. Tutika, J. Y. Kim, and M. D. Bartlett, “Solid-liquid composites for soft multifunctional materials,” Advanced Functional Materials, vol. 31, no. 1, p. 2005804, 2021.
[56] R. Tutika, S. H. Zhou, R. E. Napolitano, and M. D. Bartlett, “Mechanical and functional tradeoffs in multiphase liquid metal, solid particle soft composites,” Advanced Functional Materials, vol. 28, no. 45, p. 1804336, 2018.
[57] S. H. Jeong, S. Chen, J. Huo, E. K. Gamstedt, J. Liu, S.-L. Zhang, Z.-B. Zhang, K. Hjort, and Z. Wu, “Mechanically stretchable and electrically insulating thermal elastomer composite by liquid alloy droplet embedment,” Scientific reports, vol. 5, no. 1, pp. 1-10, 2015.
[58] Y. Gao and J. Liu, “Gallium-based thermal interface material with high compliance and wettability,” Applied Physics A, vol. 107, no. 3, pp. 701-708, 2012.
[59] S. Mei, Y. Gao, Z. Deng, and J. Liu, “Thermally conductive and highly electrically resistive grease through homogeneously dispersing liquid metal droplets inside methyl silicone oil,” Journal of Electronic Packaging, vol. 136, no. 1, p. 011009, 2014.

### ASPECTS

The disclosure will be better understood by reading the following numbered aspects, which should not be confused with the claims. In some instances, one or more aspects can be combined or combined with aspects described elsewhere in the disclosure or aspects from the examples without deviating from the invention. The following listing of exemplary aspects supports and is supported by the disclosure provided.

Aspect 1. A method of adhering a liquid metal composite to a substrate, the method comprising applying a pretreatment to a surface of the substrate to form an activated surface; contacting a silane with the activated surface to form a functionalized surface; contacting the functionalized surface with a liquid metal composite precursor; and curing the liquid metal composite precursor while in contact with the functionalized surface to form the liquid metal composite adhered to the substrate.

Aspect 2. The method according to any one of the foregoing Aspects wherein the pretreatment is selected from the group consisting of ozone treatment, oxygen plasma treatment, wet oxidation treatment, electrochemical oxidation, and a combination thereof.

Aspect 3. The method according to any one of the foregoing Aspects wherein the pretreatment comprises oxygen plasma treatment.

Aspect 4. The method according to any one of the foregoing Aspects wherein the silane comprises a multifunctional silane having two or more alkoxy groups.

Aspect 5. The method according to any one of the foregoing Aspects, wherein the silane comprises an amino or aminoalkyl group.

Aspect 6. The method according to any one of the foregoing Aspects, wherein the silane comprises a reactive vinyl group.

Aspect 7. The method according to any one of the foregoing Aspects, wherein the silane is selected from the group consisting of trimethoxysilane (TMS), triethoxysilane (TES), aminopropyltriethoxysilane (APTES), vinyltrimethoxysilane (VTMS), N-(6-aminohexyl)aminomethyltriethoxysilane (AHAMTES), and a combination thereof.

Aspect 8. The according to any one of the foregoing Aspects, wherein the silane is an (aminoalkyl)trialkoxysilane.

Aspect 9. The method according to any one of the foregoing Aspects wherein the (aminoalkyl)trialkoxysilane is a compound of formula (I):

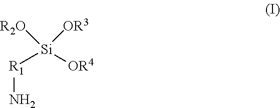

wherein R₁ is a C₂ to C₆ divalent linear alkylene radical optionally substituted by one or more halogen; and
R₂, R₃, and R₄ are independently selected from methyl, ethyl, propyl, isopropyl, n-butyl, isobutyl, sec-butyl, and tert-butyl.

Aspect 10. The method according to any one of the foregoing Aspects, wherein R₁ is selected from the group consisting of —CH₂CH₂—, CH₂CH₂CH₂—, —CH₂CH₂CH₂CH₂—, —CH₂CH₂CH₂CH₂CH₂—, and —CH₂CH₂CH₂CH₂CH₂CH₂—.

Aspect 11. The method according to any one of the foregoing Aspects, wherein R₁ is selected from the group consisting of —CH₂CH₂—, CH₂CH₂CH₂—, —CH₂CH₂CH₂CH₂—, and —CH₂CH₂CH₂CH₂CH₂—.

Aspect 12. The method according to any one of the foregoing Aspects, wherein R₁ is selected from the group consisting of —CH₂CH₂—, CH₂CH₂CH₂—, and —CH₂CH₂CH₂CH₂.

Aspect 13. The method according to any one of the foregoing Aspects, wherein R₁ is —CH₂CH₂— or —CH₂CH₂CH₂—.

Aspect 14. The method according to any one of the foregoing Aspects, wherein the silane is contacted with the activated surface in a solution comprising the silane and a solvent.

Aspect 15. The method according to any one of the foregoing Aspects, wherein the solvent is selected from the group consisting of methanol, ethanol, n-propanol, combinations thereof, and mixtures thereof comprising one or more additional solvents.

Aspect 16. The method according to any one of the foregoing Aspects, wherein the solvent comprises ethanol.

Aspect 17. The method according to any one of the foregoing Aspects, wherein the solvent consists essentially of ethanol.

Aspect 18. The method according to any one of the foregoing Aspects, wherein the solvent consists of ethanol.

Aspect 19. The method according to any one of the foregoing Aspects, wherein the solution is substantially anhydrous.

Aspect 20. The method according to any one of the foregoing Aspects, wherein the silane is present in the solution in an amount from about 0.05 vol % to about 2 vol %.

Aspect 21. The method according to any one of the foregoing Aspects, wherein step (b) further comprises drying the activated surface to remove the solvent thereby forming the functionalized surface.

Aspect 22. The method according to any one of the foregoing Aspects, wherein the substrate is a rigid substrate.

Aspect 23. The method according to any one of the foregoing Aspects, wherein the rigid substrate is a rigid sheet.

Aspect 24. The method according to any one of the foregoing Aspects, wherein the substrate comprises a metal selected from the group consisting of titanium, copper, aluminum, iron, nickel, zinc, and chromium, and alloys comprising any one or more of the foregoing metals.

Aspect 25. The method according to any one of the foregoing Aspects, wherein the substrate comprises a metal alloy selected from the group consisting of stainless steels.

Aspect 26. The method according to any one of the foregoing Aspects, wherein the substrate has a Young's modulus as measured according to ASTM E111 protocol of from 50 GPa to 200 Gpa.

Aspect 27. The method according to any one of the foregoing Aspects, wherein the substrate is selected from the group consisting of an acrylate a methacrylate, a siloxane, a polyethylene, a polypropylene, a polybutylene, a polycarbonate, a polyvinyl chloride, a polyester, a copolyester, a polycarbonate, an acrylonitrile butadiene styrene (ABS), and blends and composited thereof.

Aspect 28. The method according to any one of the foregoing Aspects, wherein the substrate has a Young's modulus as measured according to ASTM E111 protocol of from 0.001 Gpa to 10 Gpa.

Aspect 29. The method according to any one of the foregoing Aspects, wherein the drying is performed for a first period of time from about 0.1 hours to 1 hour, about 0.5 hours to 5 hours, or about 0.5 hours to 24 hours.

Aspect 30. The method according to any one of the foregoing Aspects, wherein during the drying step the substrate is heated to from 30° C. to about 50° C.

Aspect 31. The method according to any one of the foregoing Aspects, wherein curing the liquid metal composite precursor comprises one or more of heating the liquid metal composite precursor, exposing the liquid metal composite precursor to UV radiation, and contacting the liquid metal composite precursor with a chemical crosslinking agent.

Aspect 32. The method according to any one of the foregoing Aspects, wherein the curing comprises heating the liquid metal composite precursor to an elevated temperature for a second period of time.

Aspect 33. The method according to any one of the foregoing Aspects, wherein the liquid metal composite precursor comprises an uncured elastomeric polymer having droplets of liquid metal dispersed therein.

Aspect 34. The method according to any one of the foregoing Aspects, wherein the liquid metal composite precursor comprises a partially cured elastomeric polymer having droplets of liquid metal dispersed therein.

Aspect 35. The method according to any one of the foregoing Aspects, wherein the elastomeric polymer is selected from the group consisting of a polysiloxane, a polyurethane, a polyacrylate, a natural rubber, copolymers thereof, and blends thereof.

Aspect 36. The method according to any one of the foregoing Aspects, wherein the elastomeric polymer comprises a polysiloxane elastomer.

Aspect 37. The method according to any one of the foregoing Aspects, wherein the liquid metal is selected from the group consisting of eutectic gallium indium, gallium alloys, gallium-indium-tin, and mercury.

Aspect 38. The method according to any one of the foregoing Aspects, wherein the polysiloxane elastomer is platinum-curable.

Aspect 39. The method according to any one of the foregoing Aspects, wherein the polysiloxane elastomer is tin-curable.

Aspect 40. The method according to any one of the foregoing Aspects, wherein the polysiloxane elastomer is heat-curable.

Aspect 41. The method according to any one of the foregoing Aspects, wherein the liquid metal is selected from the group consisting of GaIn_{24.5}, (eutectic gallium indium or EgaIn), Ga₆₇In_{20.5}Sn_{12.5} (Galinstan), and Ga₆₁In₂₅Sn₁₃Zn₁.

Aspect 42. The method according to any one of the foregoing Aspects, wherein a volume fraction of liquid metal in the composite is from 1% to 60%.

Aspect 43. The method according to any one of the foregoing Aspects, wherein a diameter of the liquid metal droplet is from about 100 nm to about 1 μm, from about 1 μm to about 100 μm, or from about 100 μm to about 300 μm.

Aspect 44. An article prepared by the method according to any one of the foregoing Aspects, comprising the substrate and the liquid metal composite adhered to the substrate.

Aspect 45. The article of Aspect 44, wherein the liquid metal composite is a shaped liquid metal composite comprising one or more surfaces.

Aspect 46. The article according to any one of the foregoing Aspects, wherein the liquid metal composite comprises a first surface and a second surface, wherein at least a portion of the first surface is adhered to a portion of the substrate.

Aspect 47. The article according to any one of the foregoing Aspects, wherein a portion of the liquid metal composite is resiliently biased against the portion of the first surface adhered to the portion of the substrate.

Aspect 48. The article according to any one of the foregoing Aspects, further comprising an electronic component adhered to the liquid metal composite.

Aspect 49. The method according to any one of the foregoing Aspects, wherein the steps of (c) and (d) comprise 3D printing of the liquid metal composite precursor onto the functionalized surface and curing the 3D printed liquid metal composite precursor contemporaneous with or immediately after the 3D printing step.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Fabrication

### Liquid Metal Composite Fabrication

LM droplets were fabricated using an in-situ technique where the bulk LM was first added to uncured elastomer (Ecoflex 00-30, Smooth-On, Inc.) and mixed with a stirring rod for 2 min. To achieve droplet diameters of 80 and 20 μm, solutions containing 66 vol % LM in elastomer were shear mixed in a dual asymmetric centrifuge (DAC 1200-500 VAC, FlackTek) at 1200 and 1700 RPM, respectively. To fabricate droplets with a 2 μm diameter, separate solutions containing 70 vol %. LM in prepolymer and LM in curing agent were mixed using an overhead mixer (6015 Ultra Speed, Caframo) at 6000 RPM. Emulsions containing the desired droplet sizes were then diluted with uncured elastomer to set the volume loading.⁵⁶ In the case of 2 μm droplet size, the separate 70 vol % solutions were combined 1:1 and subsequently diluted. The final composites were cast into molds to prepare the samples for testing.

### T-Peel Fabrication

PET adherends were laser cut into 125 mm×20 mm strips from stock sheets of 125 μm-thick PET. After cleaning with isopropyl alcohol, the strips were treated with oxygen plasma (3 min, 300 mTorr oxygen, 400 W, PE-75 Series, Plasma Etch, Inc.) to functionalize the surface in preparation for APTES treatment. The plasma-treated PET strips were then dip coated in a 0.1 vol % APTES in ethanol solution and placed onto a glass plate to dry for 5 h. Ecoflex and LM composite samples were cast directly onto an APTES-treated PET adherend placed underneath a 75 mm×15 mm×3.2 mm acrylic mold. A second APTES-treated PET adherend was laid on top of the uncured sample. The completed T-peel specimen was cured at 80° C. for at least 12 h. Viscous composites such as φ=60%, d=2 μm were cured at room temperature for 12-15 h and then at 80° C. for 3 hours. After curing, the mold was removed and a 10 mm pre-crack was cut through the midplane of the thickness and along the sample length using a razor blade.

### 90° Peel Fabrication

Substrates were cleaned with isopropyl alcohol, treated with oxygen plasma, submerged into a 0.1 vol % APTES in ethanol solution, and left to dry. An acrylic mold was secured on top of the treated substrate and the LM composite was cast onto the substrate surface. Finally, an APTES-treated PET adherend was placed on top of the uncured sample and the specimen was left to cure at room temperature for at least 12 hours. Following room temperature curing, the mold was removed, and the sample was cured at 80° C. for 3 hours. 90° peel specimens were also given a 10 mm pre-crack prior to testing.

### Stretchable Electronics LED Sample Fabrication

Copper strips 60 mm in length (Basic Copper) and LEDs (Cree XLAMP XHP50 GEN 3, Digi-Key Electronics) were cleaned with isopropyl alcohol, treated with oxygen plasma, submerged into a 0.1 vol % APTES in ethanol solution, and left to dry. Two strips were then secured with VHB tape at 25 mm along the length on each side of a 170 mm×40 mm acrylic backing layer, and the sample mold was then secured on top of this assembly with electrical tape. The sample was cast into the mold and cured at 80° C. for 60-90 min. After curing, the sample was removed from the mold and LM traces were spray coated onto the sample using a stencil made from laser patterned orange mask (Blazer Orange Laser Mask, Johnson Plastics Plus). The LED heat sink was dabbed with uncured sample, placed onto the center of the specimen, and cured at 40° C. for 1 h. After curing, an electrically conductive network was completed by using EGaIn-copper paste to connect the LM traces to the edges of the copper strips and LED leads.

### Characterization

### Peel Specimens

T-peel samples were tested under uniaxial tension and 90° peel samples were tested using a wire cable actuated test apparatus on an Instron 5944 universal testing system. T-peel and 90° peel tests were performed at an extension rate of 254 and 60 mm/min, respectively. Fracture energy was calculated from the plateau region of the load-displacement curve.

### Tension Tests

Mechanical properties were measured under uniaxial tension. Dogbone specimens were die-cut according to 50% dimensions of ASTM D412-C specimens. The test was performed at an extension rate of 1 mm/s using an Instron 5944 universal testing system. Tensile modulus was calculated from the stress-strain curve up to 5% strain.

### Optical Microscopy

Optical micrographs were obtained using a Zeiss Axio Zoom v16 stereo microscope.

### Droplet Analysis

Fiji software was used to perform particle analysis in which the area of a droplet was calculated from a binary image and an ellipse of that area was fit on the particle. The mean particle size and standard deviation were calculated from plotting a histogram of the major diameters of the ellipses and utilizing Gaussian and lognormal fits on the data

### Graphics Card Performance Benchmarking

The performance of a Visiontek Radeon 5450 graphics card was evaluated by measuring idle temperatures and running Unigine Heaven 4.0 as a benchmark program. The computer was a Dell Precision 5820 Tower X-series with an i9-10900X CPU and 32 GB of RAM. All tests were conducted with the side panel of the computer removed. To measure GPU temperature, the TechPowerup GPU-Z program was used, and “GPU Temp 1” was recorded. To measure the idle temperature, the computer was turned on and GPU-Z tool measures the temperature after steady-state was achieved for at least ten minutes. To record the refresh rate, MSI Afterburner with Rivatuner Statistics Server was used. During benchmark testing, the rendered resolution was 1280×720 in DirectX 11 mode, and all settings were set to low with tessellation, stereo 3D, multi-monitor, and anti-aliasing disabled. No other processes were conducted on the computer for the duration of the benchmark. After a benchmark run was conducted, the computer was left unused until the GPU temperature returns to its idle state before starting another benchmark run.

### Statistical Analysis

The meaning of all error bars was described within the captions of the corresponding figures.

### Results

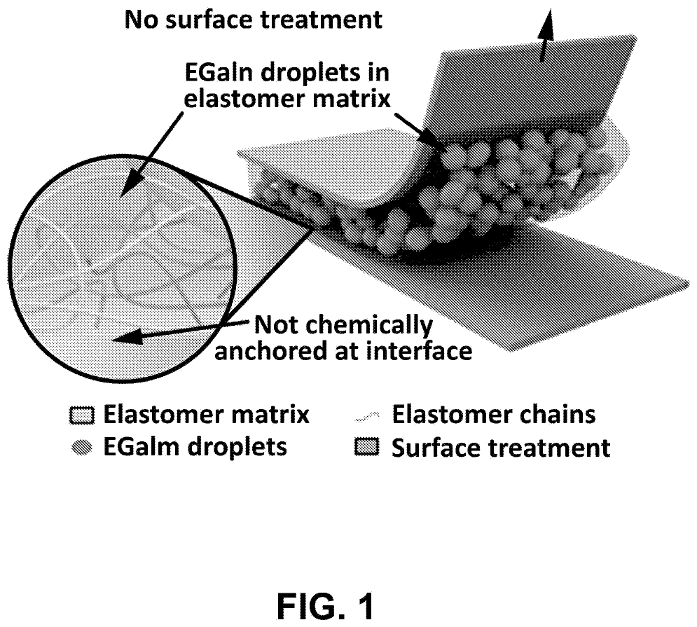

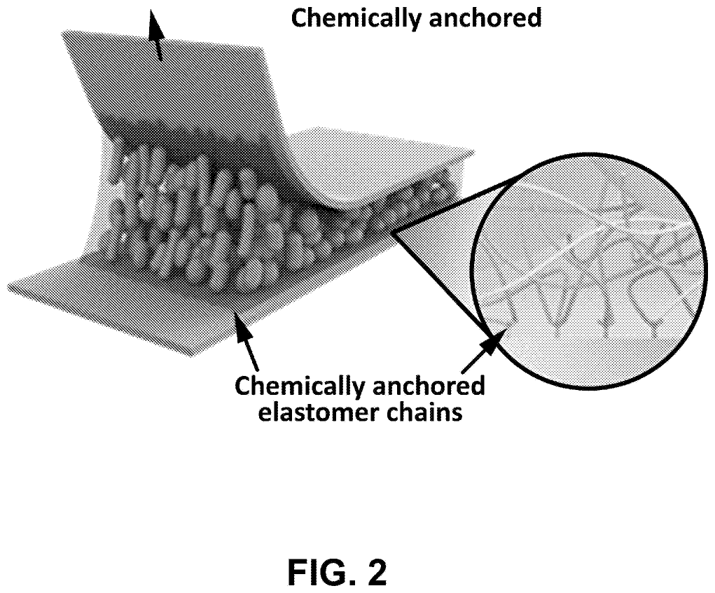

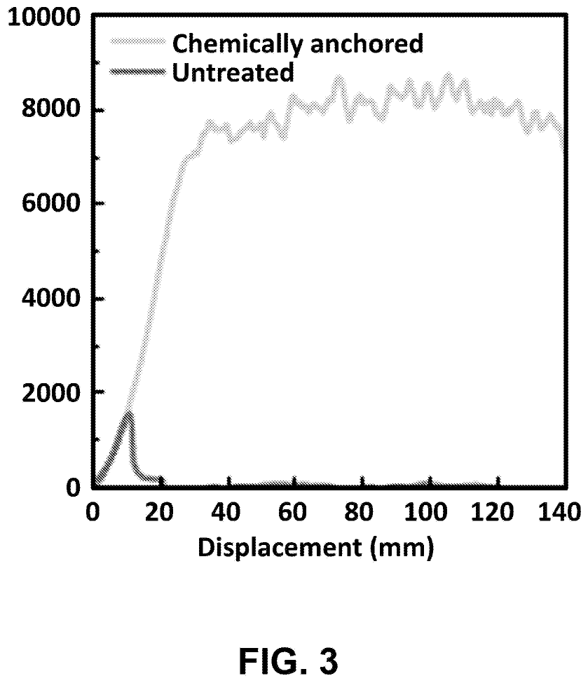

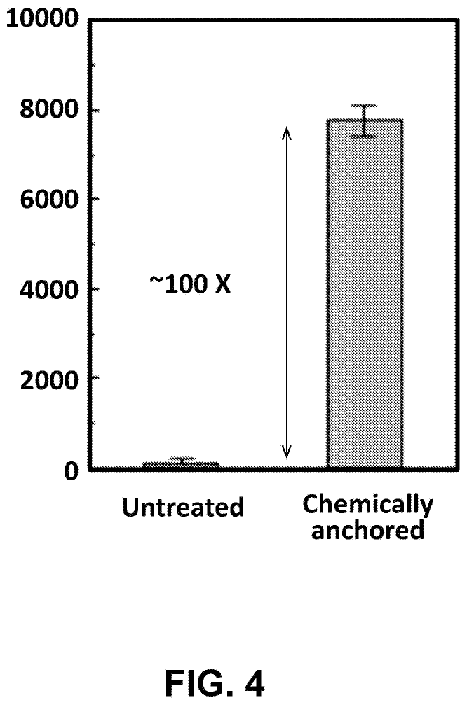

Strong bonding was achieved by chemically anchoring LM composites to various materials through a surface treatment process that uses oxygen plasma and APTES (FIG. 1, FIG. 2) This approach increased the fracture energy (G_{c}) of peel specimens by up to 100× relative to specimens with no treatment (FIG. 3, FIG. 4), with maximum values around 7800 J m⁻². Furthermore, the adhesives can bear heavy loads. The strength of the adhesive was demonstrated by suspending three bricks (total mass 6.8 kg) from a pre-cracked peel specimen with a width of 15 mm (FIG. 2). It was found that by varying LM droplet size from 2-60 μm and volume loading from 20-60%, the fracture energy could be tuned with tensile modulus and thermal conductivity. These results show that the smallest droplets lead to the highest values of G_{c} and modulus, while thermal conductivity was similar over different size droplets, thus demonstrating control of toughness and thermal properties. Finally, potential applications of this tough bonding approach were demonstrated in soft robotics and electronics by chemically anchoring rigid materials and electronic components to LM composite to create robust soft electronics systems. These systems were developed without encapsulation or clamping of the LM composite, thus simplifying integration while maintaining extreme deformability and exceptional thermal and electrical performance.

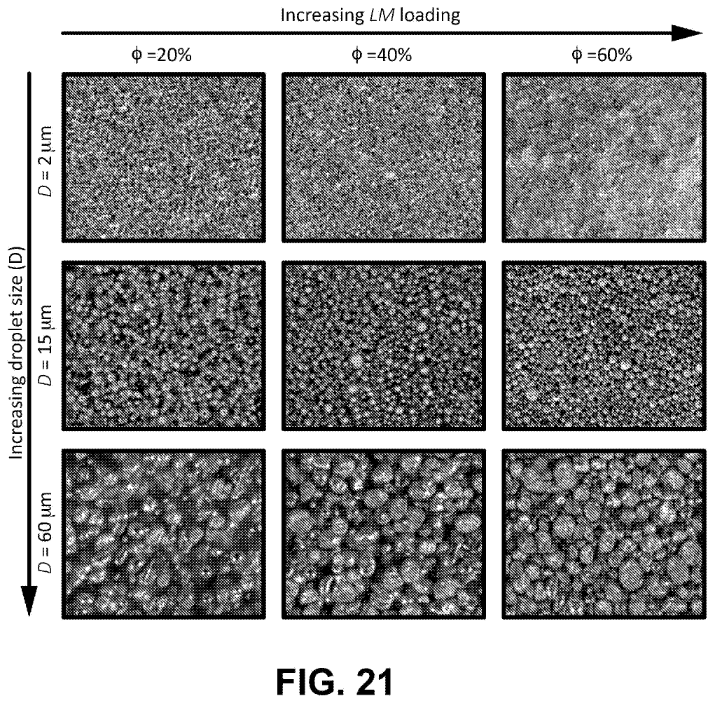

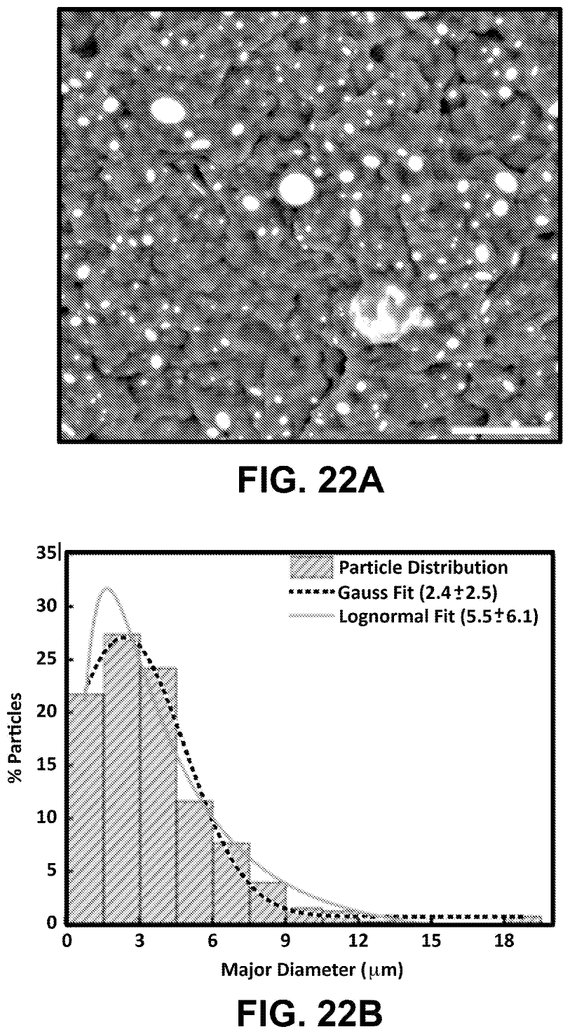

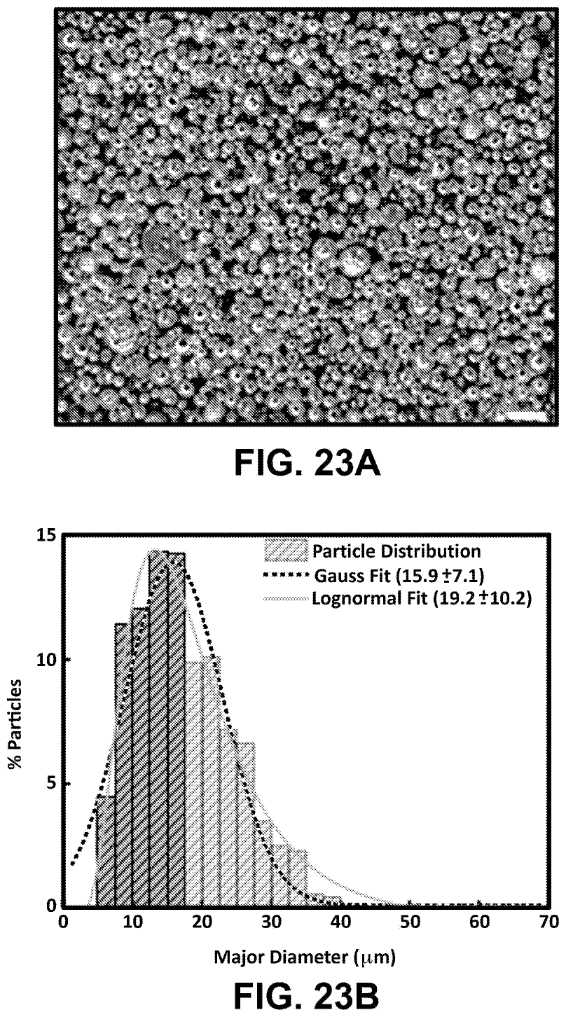

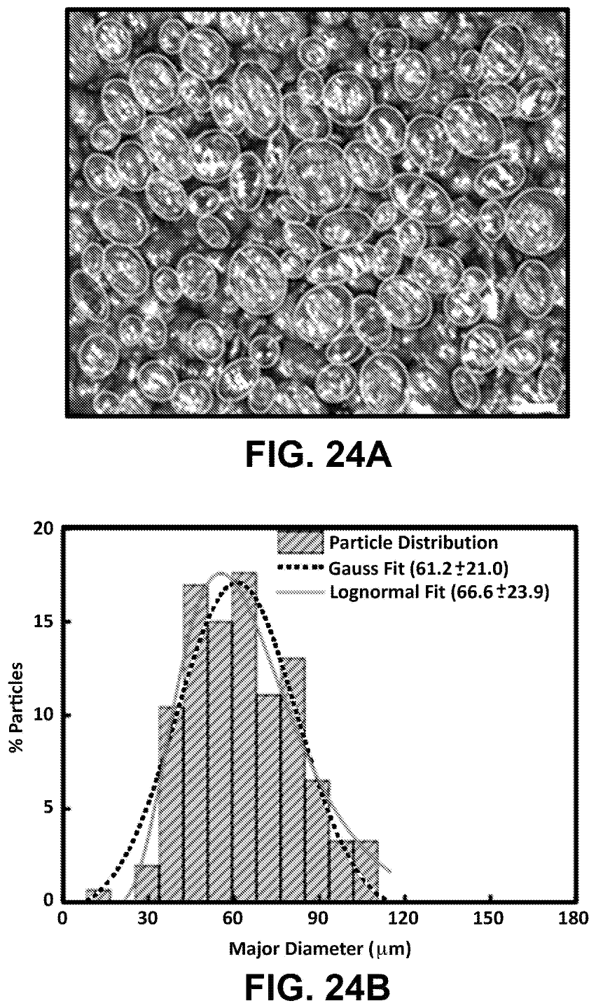

The LM composites consisted of Ecoflex silicone elastomer with dispersed droplets of eutectic gallium-indium (EGaIn). The volume fraction of LM was varied from 0≤φ≤60% with droplet sizes ranging from 2≤d≤60 μm based on particle analysis (FIG. 21, FIGS. 22A-22B, FIGS. 23A-23B, FIGS. 24A-24B). To create chemically anchored samples, substrates were treated with oxygen plasma, submerged into a 0.1 vol % APTES in ethanol solution, and allowed to dry at room temperature. Then, liquid-state LM composite was cast onto the surface and cured. Untreated samples were prepared using a similar procedure except oxygen plasma and APTES solution were not utilized (see experimental section for more details). The APTES created an abundance of functional amine groups on a material surface. Additionally, pretreating with plasma increased the amount of active sites for APTES to attach compared to a pristine material.^{46, 47} Upon casting liquid-state LM composite onto the treated surface, chemical anchoring of elastomer chains occurred through interfacial compatibilization of the silane treatment and the silicone elastomer, which could occur through the formation of an interpenetrating polymer network (IPN) between polymer chains and the silane molecules (FIG. 1).⁴⁸

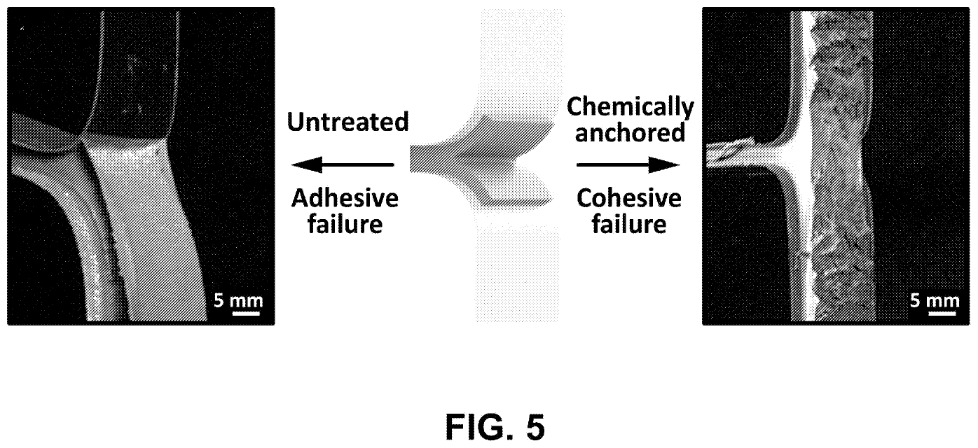

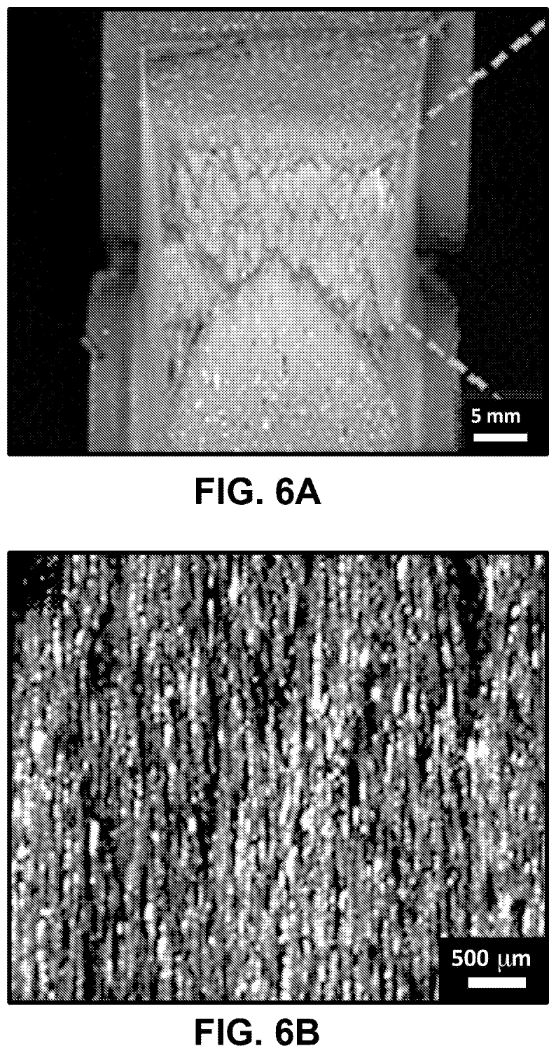

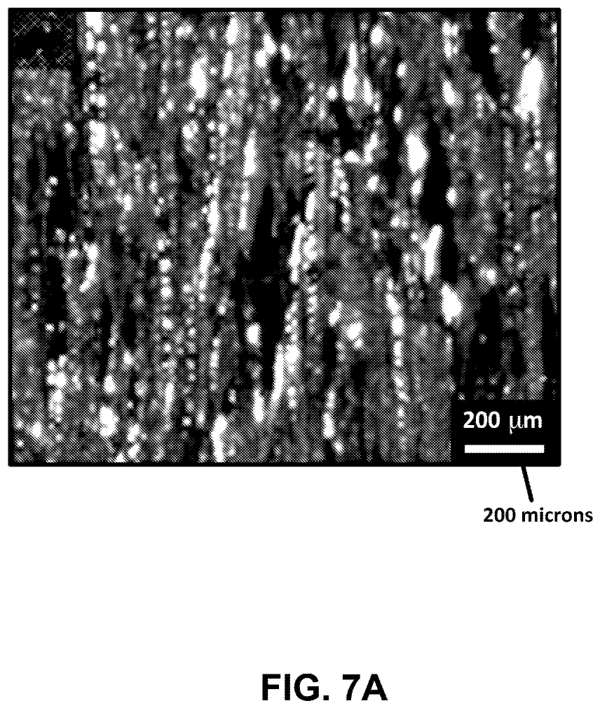

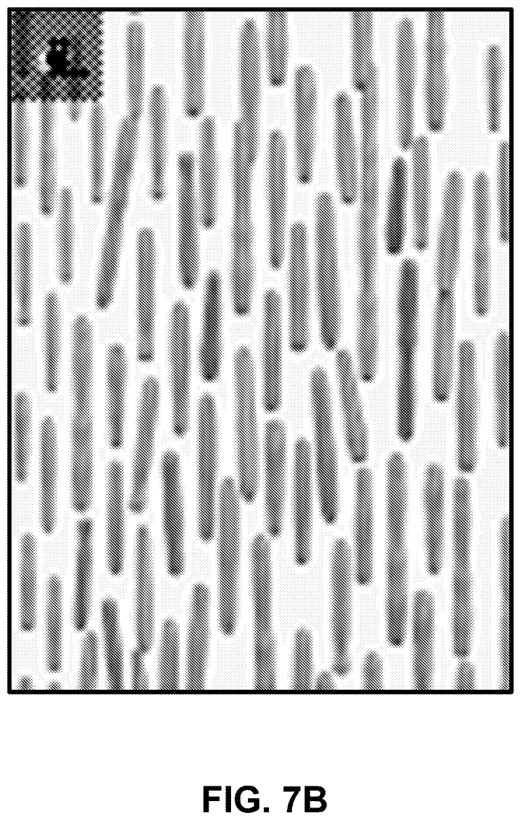

Adhesion performance was analyzed by conducting T-peel tests in which LM composite was cast between two flexible polyethylene terephthalate (PET) adherends (FIG. 5). The untreated samples experienced adhesive failure at the composite-PET interface. In contrast, the chemically anchored composites did not debond from the adherends. Instead, the crack propagated cohesively through the composite, as material fracture was more energetically favorable than breaking the interfacial bonds. To investigate LM composite fracture on the microscale, the crack front of a chemically anchored sample was monitored during peeling (FIGS. 6A-6B, FIGS. 7A-7B). There was significant deformation which resulted in the LM inclusions elongating in the damage region. This behavior was represented schematically in FIG. 7B and highlights the reconfigurable nature of the LM droplets under deformation.

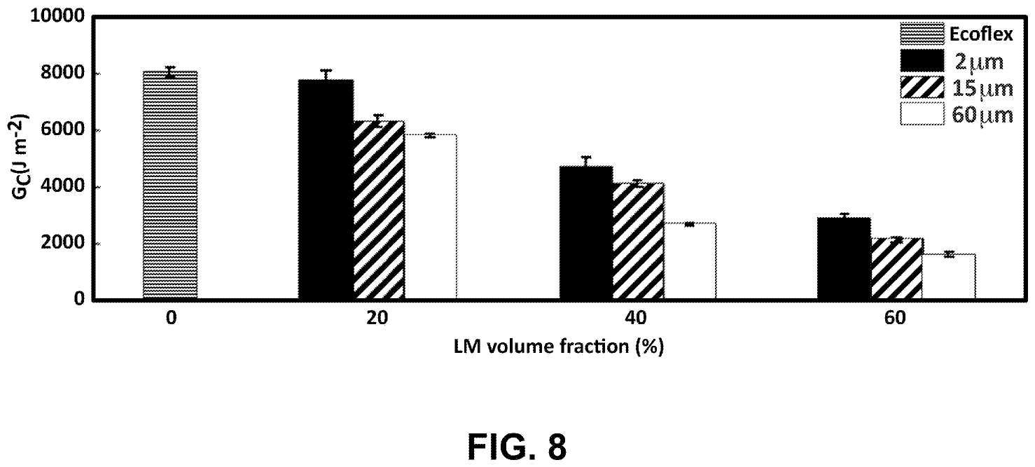

To investigate the effect of microstructure on fracture energy, nine distinct compositions of chemically anchored composites were tested under T-peel, including three LM volume loadings (φ=20, 40, 60%) each with three mean droplet diameters (d=2, 15, 60 μm). Unloaded Ecoflex samples were also fabricated (φ=0%). For each sample, the fracture energy G_{c} was obtained by normalizing the measured plateau peel force F by the composite width w, G_{c}=2F/w.^{49, 50} A decrease in volume fraction and mean droplet diameter was observed to lead to an increase in fracture energy (FIG. 8). The largest G_{c} was obtained with φ=20%, d=2 μm, which was similar to that of the unfilled elastomer. Although G_{c} decreases with increasing φ, a significant G_{c} value of 2880±150 J m^{-2 was} achieved for φ=60%. Previous work by Kazem et al. has shown that higher LM volume fractions in soft elastomers result in an extreme toughening effect;⁵¹ however, the work presented here shows a contrasting trend which was attributed to differences in the crack propagation mechanism. Kazem et al. showed that extreme toughening was a result of crack redirection due to elongation of LM inclusions perpendicular to the propagating crack. In this work, chemically anchored specimens tended to fracture in a serrated or sawtooth pattern, where the pronouncement of the pattern has been shown to depend on parameters such as loading conditions, sample thickness, and adherend thickness.^{52, 53} This characteristic serrated morphology likely results in the crack moving back and forth along the direction of loading, not directly through the centerline of the crack front. This reduced the crack deflection effectiveness of the LM droplets, allowing the crack to propagate along the inclusions, not through the inclusions where deflection could occur. Next, with regard to LM droplet size, smaller LM droplets tended to act as stiffer inclusions.⁵⁴ This has been shown through elastocapillary arguments as well as the existence of a stiff, solid oxide layer on the surface of LM droplets.⁵⁵ As LM droplet size decreases, the ratio of outer solid surface area to inner liquid volume increases, resulting in a higher effective stiffness. This trend was similar to elastocapillarity, which states that the surface tension of liquid inclusions will stiffen a composite when the inclusion size was sufficiently small. This increased composite stiffness tends to toughen the LM composites for the same φ as observed in FIG. 8.

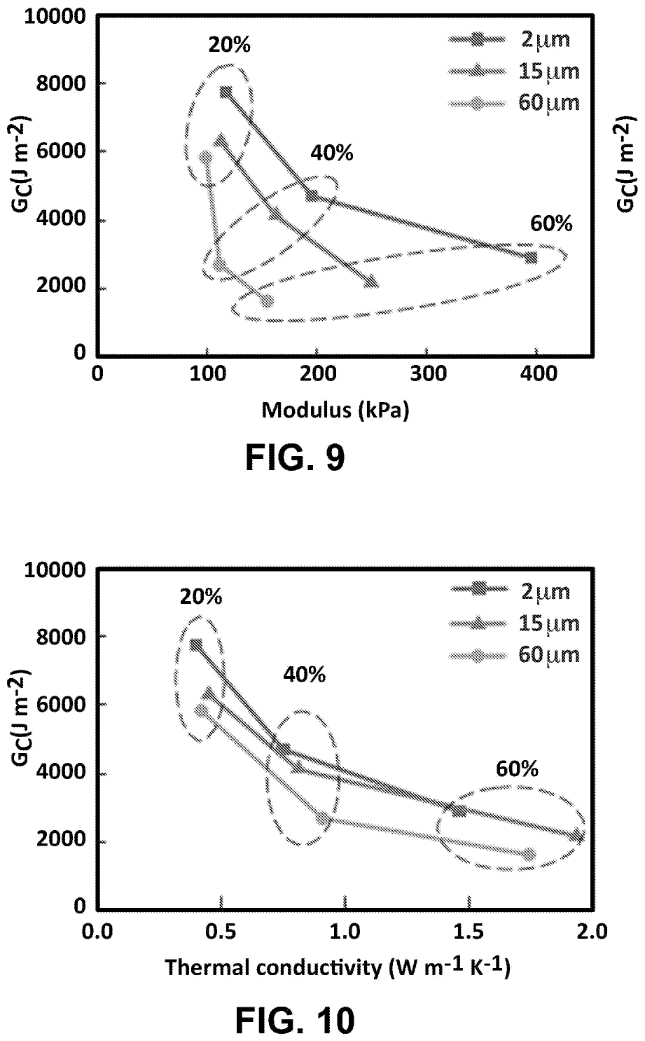

In an aspect, the present LM composites can have desirable thermal and mechanical properties while also achieving tough adhesion to various substrates. FIG. 9 shows the relationship between G_{c} and composite modulus. By controlling the volume loading and mean LM droplet diameter, composites with prescribed combinations of toughness and modulus could be created. For example, by maintaining an LM volume fraction of 20% and changing the mean droplet diameter from 2 to 60 μm, the fracture energy could be tuned by ˜2000 J m⁻² with a slight change in modulus of less than 20 kPa. In contrast, at higher LM volume fractions, the mean LM droplet diameter was shown to have a greater effect on modulus than on toughness. At a volume fraction of 60%, a change in modulus of over 240 kPa results in a change in G_{c} of 1275 J m⁻² as mean droplet diameter was changed from 2 to 60 μm.

The thermal conductivity of these composites could also be tuned while controlling the fracture energy. FIG. 10 shows the relationship between G_{c} and k, where G_{c} generally decreases with increasing composite thermal conductivity. The thermal conductivity does not display a pronounced dependence on LM droplet diameter, and instead was dependent on volume fraction. In contrast, changes in droplet size have a noticeable effect on fracture energy. These findings were enabling for the development of LM composite adhesives with desired combinations of thermal conductivity and fracture energy, which could be controlled by LM volume fraction and droplet size respectively.

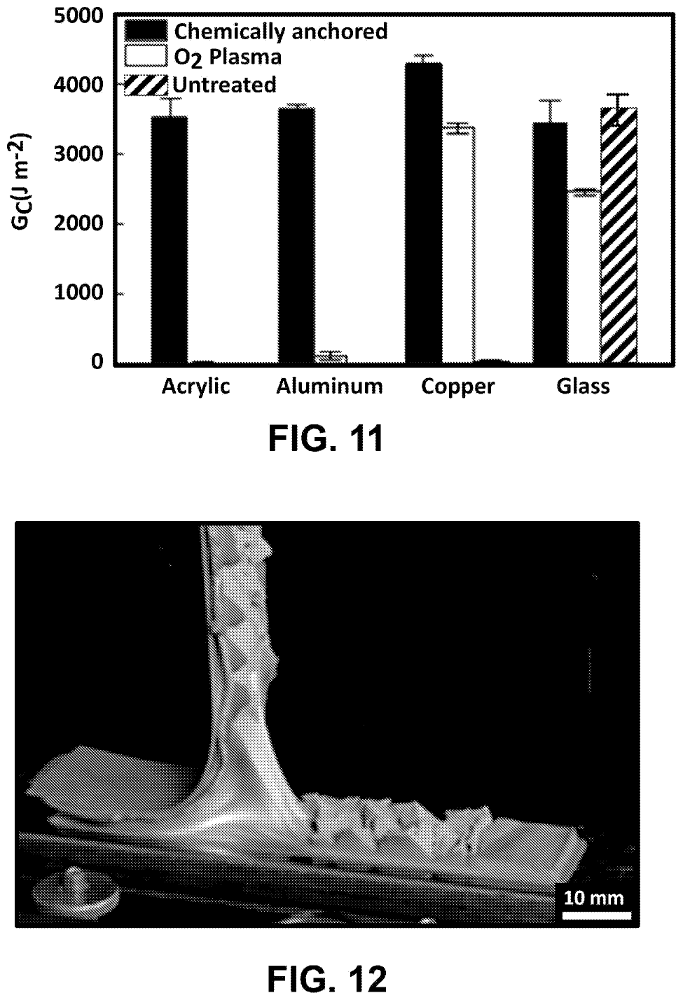

In order to show the broad application of the chemical anchoring technique, one composition of LM composite (φ=40%, d=15 μm) was bonded to several rigid, non-porous substrates. The fracture energy was then measured via 90° peel test, for which G_{c}=F/w (FIG. 11). All untreated samples, except for glass, experience adhesive failure at the composite-substrate interface. This results in very low adhesion (<10 J m⁻² for acrylic and aluminum and <50 J m⁻² for copper), as was commonly observed with silicones and LM composites. Oxygen plasma treatment without APTES was also performed, where only select substrates showed strong adhesion such as copper and glass, while acrylic and aluminum showed low adhesion. In contrast, all chemically anchored samples that utilize both oxygen plasma and APTES treatment fracture through the composite thickness with G_{c} values over 3000 J/m².

The cohesive fracture energy measured in 90° peel for the chosen sample composition was similar to that measured in T-peel. Furthermore, samples tested in 90° peel also display a serrated or sawtooth appearance of the fracture surface (FIG. 12) Given these results, the chemical anchoring technique was promising for the incorporation of LM composites into larger systems consisting of diverse materials.

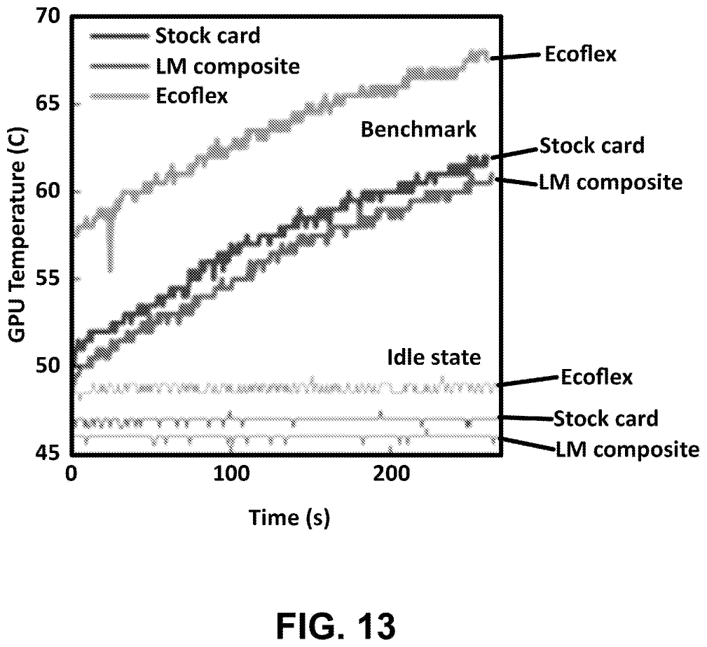

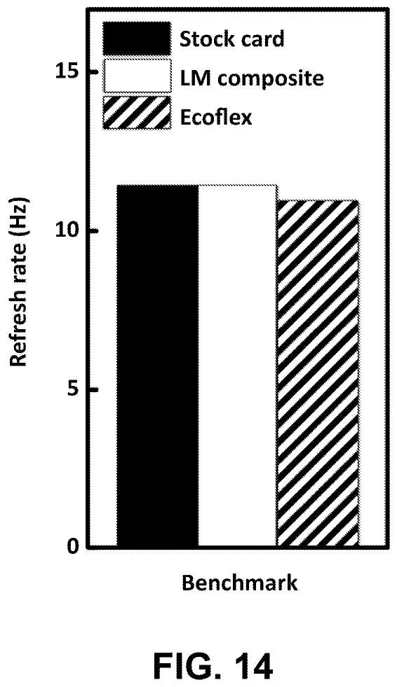

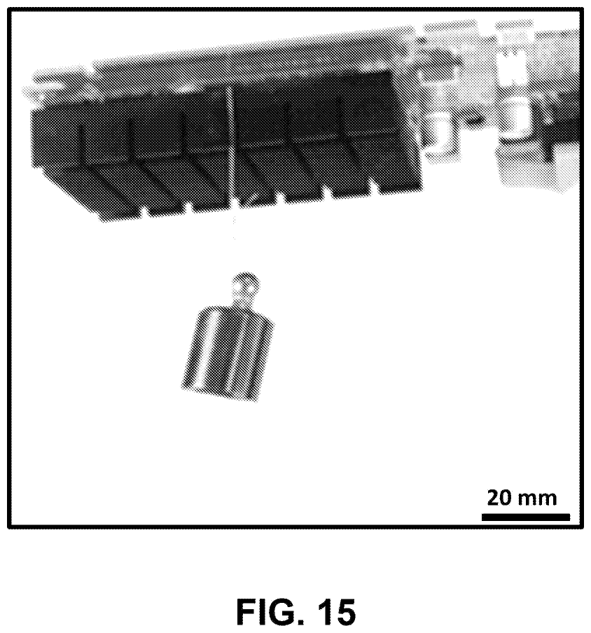

The high thermal conductivity of LM composite gives rise to its use as a thermal interface material (TIM) in modern electronics.^{14, 27, 58} Furthermore, an electrically insulating matrix such as Ecoflex lessens the risk of electrical shorting, mitigates the corrosive effect of gallium,^{26, 59} and allows for chemical anchoring techniques to be leveraged. To demonstrate, computer graphics benchmark tests were conducted using the as-received thermal compound between the graphics processing unit (GPU) and a passive heatsink. The compound was then replaced with chemically anchored LM composite (φ=60%, d=60 μm) and unfilled Ecoflex. It was found that the GPU temperature and performance with LM composite was similar to the stock thermal compound (FIG. 13, FIG. 14). However, Ecoflex performs notably worse, as the GPU reaches much higher temperatures. Finally, to demonstrate strong adhesion from chemical anchoring, the screws holding the heatsink (66 grams) in place on the GPU circuit board were removed and an additional 50 g mass was suspended near the 7.6×9 mm area containing the chemically anchored LM composite (FIG. 15). The strong adhesion and thermal control of the LM composite could be leveraged for future integrated systems within rigid electronics applications.

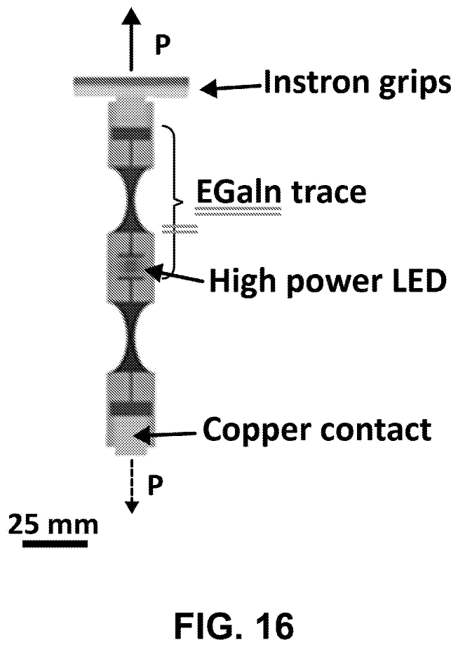

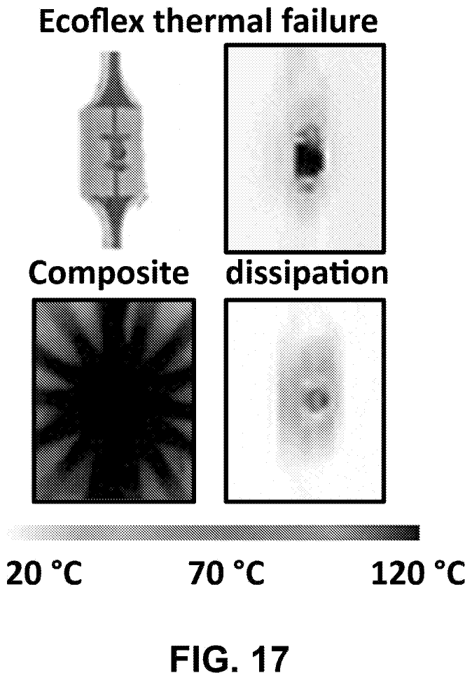

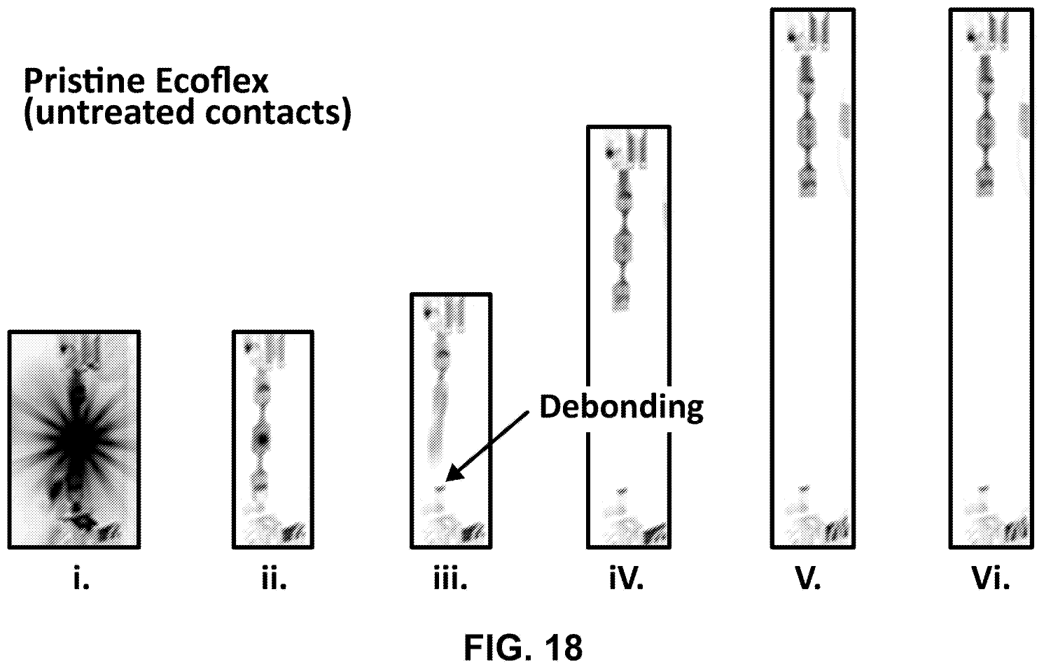

Along with its high thermal conductivity, LM composite demonstrated exceptional stretchability and toughness, and these properties were especially important to the emerging field of stretchable electronics. To demonstrate a stretchable electronics system which leverages all three properties, a LM composite sample was created in which electronic components and external leads were directly integrated without encapsulation or clamping. A high-power LED (Cree Extreme High Power (XHP)) and external copper contacts were chemically anchored to a LM composite sample (φ=60%, d=60 μm). A pristine Ecoflex sample was also created with untreated copper contacts (FIG. 16). On both samples, LM traces were spray coated from the copper to the LED contacts to complete an electrically conductive network. The LEDs were supplied with a current of 0.6 A while the samples remain unstretched, resulting in a power output of ˜3 W with a high brightness. After 80 s, the LED anchored to the Ecoflex sample reached a temperature over 135° C., leading to thermal failure (FIG. 17, FIG. 18, FIG. 19). The LED anchored to the composite reached a temperature of approximately 85° C. and remained on after the same amount of time (FIG. 17, FIG. 19). At this point, both the samples were stretched and at ˜35% global strain, the Ecoflex sample completely detaches from the untreated bottom copper contact and the top grip continues to rise (FIG. 18). In comparison, the LM composite remains anchored to its treated copper contacts until ˜310% global strain, at which the sample fractures at the bottom neck, breaking the LED circuit (FIG. 19). Thus, chemical anchoring prevents failure due to debonding between components and instead allows for system design based on the mechanical properties of the composite material. Furthermore, the LM composite allowed for more efficient thermal dissipation, while the pristine polymer demonstrated poor thermal properties.

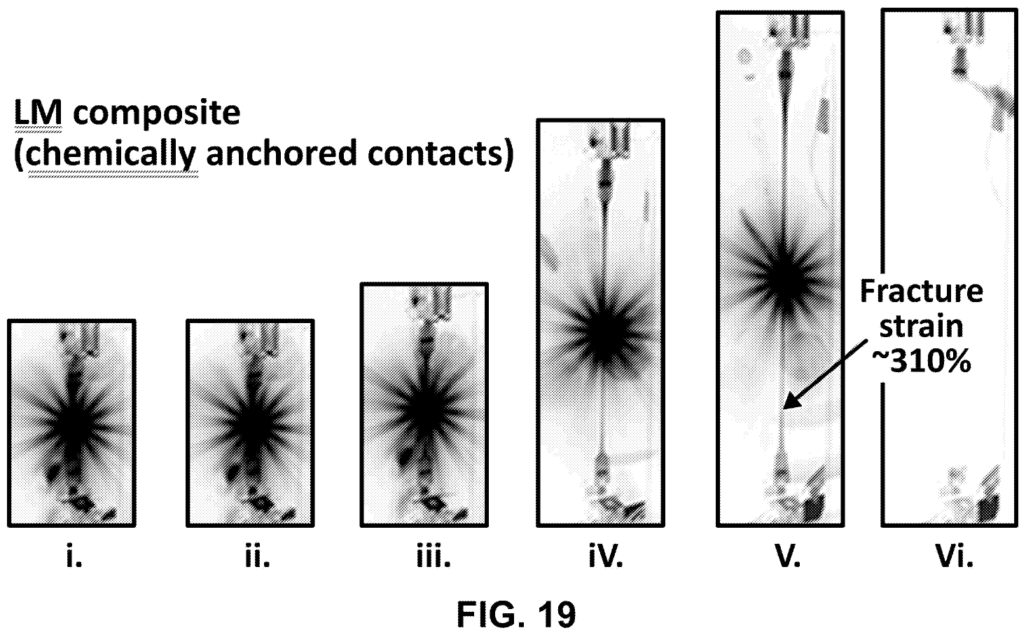

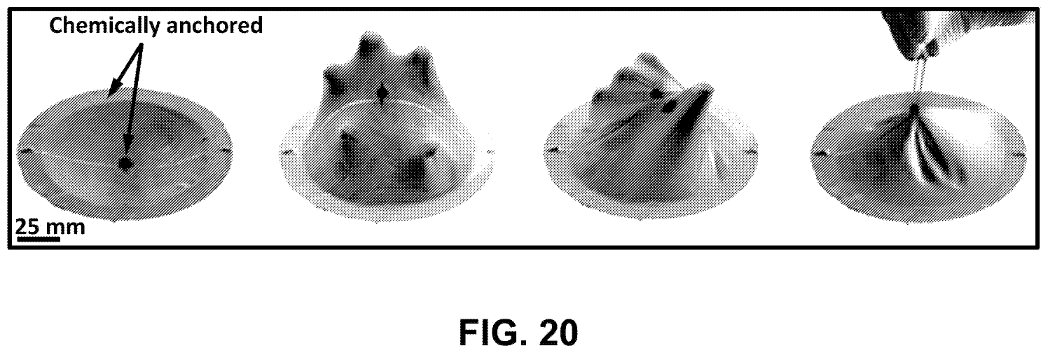

The use of chemically anchored LM composites in stretchable electronics systems was further demonstrated through the robust attachment of a circular membrane film (750 μm) to an LED and a supporting acrylic substrate, without encapsulation or mechanical clamping (FIG. 20). After supplying the LED with 0.05 A current, the system was subjected to tensile and torsional stresses. During each stress scenario, the film remains bonded to the acrylic substrate and the LED remains on (FIG. 20). Additionally, the LED does not detach from the composite even when stress concentration occurs across the small interfacial area by pulling the LED with tweezers (FIG. 20). These characteristics demonstrate the exceptional toughness of the chemically anchored interfaces as well as the ability to leverage the functional properties of LM composites for the creation of robust, stretchable systems.

Tough adhesion was achieved through the functionalization of surfaces with oxygen plasma and APTES, which allows for chemical anchoring of elastomer chains to a desired material. Chemical anchoring leads to steady-state crack propagation in the composite layer, resulting in an increase in fracture energy of up to 100× relative to samples with untreated adherends. The fracture energy was controlled by LM composite microstructural parameters such as droplet size and volume loading. Additionally, G_{c} demonstrates paired tunability with other functional properties such as modulus and thermal conductivity. Notably, the fracture energy of the toughest composite system (φ=20%, d=2 μm) was similar to that of the pristine elastomer (φ=0%).

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It was intended that the specification and examples be considered as exemplary only, with a true scope and spirit of the disclosure being indicated by the following claims.

1. A method of adhering a liquid metal composite to a substrate, the method comprising:
applying a pretreatment to a surface of the substrate to form an activated surface;
contacting a silane with the activated surface to form a functionalized surface;
contacting the functionalized surface with a liquid metal composite precursor; and
curing the liquid metal composite precursor while in contact with the functionalized surface to form the liquid metal composite adhered to the substrate.

2-3. (canceled)

4. The method of claim 1, wherein the silane comprises a multifunctional silane having two or more alkoxy groups.

5. The method of claim 1, wherein the silane comprises an amino or aminoalkyl group.

6. The method of claim 1, wherein the silane comprises a reactive vinyl group.

7. The method of claim 1, wherein the silane is selected from the group consisting of trimethoxysilane (TMS), triethoxysilane (TES), aminopropyltriethoxysilane (APTES), vinyltrimethoxysilane (VTMS), N-(6-aminohexyl) aminomethyltriethoxysilane (AHAMTES), and a combination thereof.

8. The method of claim 1, wherein the silane is an (aminoalkyl) trialkoxysilane.

9-13. (canceled)

14. The method of claim 1, wherein the silane is contacted with the activated surface in a solution comprising the silane and a solvent.

15. The method of claim 14, wherein the solvent is selected from the group consisting of methanol, ethanol, n-propanol, combinations thereof, and mixtures thereof comprising one or more additional solvents.

16-18. (canceled)

19. The method of claim 14, wherein the solution is substantially anhydrous.

20. The method of claim 14, wherein the silane is present in the solution in an amount from about 0.05 vol % to about 2 vol %.

21. The method of claim 14, wherein contacting the silane with the activated surface further comprises drying the activated surface to remove the solvent thereby forming the functionalized surface.

22-23. (canceled)

24. The method of claim 1 wherein the substrate comprises a metal selected from the group consisting of titanium, copper, aluminum, iron, nickel, zinc, and chromium, and alloys comprising any one or more of the foregoing metals.

25-26. (canceled)

27. The method of claim 1 wherein the substrate is selected from the group consisting of an acrylate a methacrylate, a siloxane, a polyethylene, a polypropylene, a polybutylene, a polycarbonate, a polyvinyl chloride, a polyester, a copolyester, a polycarbonate, an acrylonitrile butadiene styrene (ABS), and blends and composited thereof.

28. (canceled)

29. The method of claim 21 wherein the drying is performed for a first period of time from about 0.5 hours to 24 hours.

30. The method of claim 21 wherein during the drying the substrate is heated to from 30° C. to about 50° C.

31. The method of claim 1, wherein curing the liquid metal composite precursor comprises one or more of heating the liquid metal composite precursor, exposing the liquid metal composite precursor to UV radiation, and contacting the liquid metal composite precursor with a chemical crosslinking agent.

32. The method of claim 31, wherein the curing comprises heating the liquid metal composite precursor to an elevated temperature for a second period of time.

33. The method of claim 1, wherein the liquid metal composite precursor comprises an uncured or partially cured elastomeric polymer having droplets of liquid metal dispersed therein.

34. (canceled)

35. The method of claim 33, wherein the elastomeric polymer is selected from the group consisting of a polysiloxane, a polyurethane, a polyacrylate, a natural rubber, copolymers thereof, and blends thereof.

36. (canceled)

37. The method of claim 33, wherein the liquid metal is selected from the group consisting of eutectic gallium indium, gallium alloys, gallium-indium-tin, and mercury.

38-49. (canceled)
